(19) United States
(12) Patent Application Publication
(10) Pub. No.: US 2014/0317350 A1
(43) Pub. Date: Oct. 23, 2014

(54) PORTABLE STORAGE DEVICES FOR ELECTRONIC DEVICES

(71) Applicant: FXI TECHNOLOGIES AS, TRONDHEIM (NO)

(72) Inventors: Thomas Langas, Trondheim (NO); Asbjorn Djupdal, Trondheim (NO); Borgar Ljosland, Trondheim (NO); Torstein Hernes Dybdahl, Trondheim (NO); Qiang Zhao, Trondheim (NO)

(73) Assignee: FXI TECHNOLOGIES AS, TRONDHEIM (NO)

(21) Appl. No.: 14/358,425

(22) PCT Filed: Nov. 15, 2012
(86) PCT No.: PCT/GB2012/052840

§ 371 Date: May 15, 2014

(30) Foreign Application Priority Data
Nov. 15, 2011 (GB) 1119747.2

(51) Int. Cl. G06F 12/02

(52) U.S. Cl. CPC G06F 12/0246
USPC 711/115

(57) ABSTRACT

A portable storage device (1) includes a flash memory element (5) for providing mass storage functionality to a host device via a host device interface (4), and a computing environment (8), comprising an application processor (6), a system memory (1), and wireless interface support (a wireless connection) (12). The storage device (3) also includes a display interface (13) that is able to couple the storage device (3) to a display, such as a display screen, and via which graphical outputs generated by an operating system and applications executing in the computing environment (8) on the storage device (3) can be displayed on a display.

The present invention relates to portable storage devices, such as USB sticks, for providing portable, and supplemental, data storage for electronic devices, such as computers.

It is common to use portable storage devices, such as removable USB sticks, to provide additional storage capacity for example for storing content such as photographs, music or video, generated by or to be used by an electronic device.

While the use of such portable storage devices for providing supplemental data storage for electronic devices is well-established, the Applicants believe that there is further scope for the use of such storage devices.

For example, the Applicants have previously proposed a portable storage device, such as a USB stick, that includes, inter alia, a computing environment that can execute applications on the storage device and which can interact with a host device to allow a user of the host device to interact with and use an application running on the storage device.

The Applicants now believe that there remains scope for further improvements to portable storage devices for use with electronic devices.

According to a first aspect of the present invention, there is provided a portable storage device for providing supplemental mass storage to a host electronic device to which the storage device is coupled, the storage device comprising:

non-volatile memory for providing a mass storage function for a host electronic device to which the storage device is coupled;

a host device interface via which the storage device may be coupled to a host electronic device and provide a mass storage function to the host electronic device;

a computing environment operable to execute one or more applications on the storage device; and

a display interface for coupling the storage device to an electronic display, and via which a graphical output generated by an application that is being executed on the storage device may be displayed on a display when the storage device is coupled to a suitable display device via the display interface.

According to a second aspect of the present invention, there is provided a method of operating a system comprising an electronic display and a portable storage device having a host device interface via which the storage device may be coupled to a host electronic device and provide a mass storage function to the host electronic device, the method comprising:

coupling the storage device to the display via a display interface provided on the storage device;

executing an application in a computing environment on the storage device; and

displaying a graphical output generated by the application on the display via the display interface of the storage device.

The present invention relates to a portable storage device, such as a USB stick, that can provide a mass storage function for a host device to which it is coupled. However, as well as providing the mass storage functionality, the storage device of the present invention also includes a computing environment for executing applications on the storage device itself, and a display interface via which the storage device may be coupled to a display and display graphical outputs generated by applications being executed on the storage device.

As will be discussed further below, the Applicants believe that this combination of features in a portable storage device, and in particular the provision of a display interface, can provide a number of benefits and advantages. For example, such a device can provide computing resources in a compact and portable package (form factor) that can be used with any display that has a suitable display interface (and without, e.g., the need for the display itself to have extensive processing resources, etc.). Also, the computing environment and resources on the portable storage device do not in themselves have to be particularly powerful to provide a useful device. The device also retains its “normal” mass storage functionality and so can provide such functionality to any suitably equipped host device.

Indeed, the fact that the present invention is a mass storage device and provides mass storage functionality is particularly advantageous, as mass storage functionality is typically present in all operating systems, without the need for additional drivers. The storage device of the present invention can accordingly easily be accessed by any host device via its host device interface without the need for the host device to have any special privileges or to have any special drivers installed, etc. The mass storage functionality in combination with the computing environment and display interface also means, e.g., that it is straightforward to move files from a host device (e.g. computer) to the storage device and later display the files on a screen without requiring a connection to (or the presence of) the original host device, nor for the screen itself to have any computing resources. The mass storage functionality also means that applications on a host device do not need any special system privileges to access or control the computing environment on the storage device.

The storage device can be any suitable device that can provide a mass storage function for a (suitable) host device, i.e. a device that can provide storage for a coupled host electronic device and which supports a protocol between the storage device and the host electronic device for the purpose of storing data on (and reading data from) the storage device in which there is a master/slave interface between the host device (the master) and the storage device (the slave). It may, for example, and preferably does, comprise any suitable portable storage device, such as a non-volatile (flash) memory device. In a particularly preferred embodiment, the storage device functions as a USB memory stick (i.e. provides it mass storage functionality via a USB interface).

The non-volatile memory for providing the mass storage function for a host device can be any suitable such non-volatile memory that can store content for or generated by a host device to which the storage device is coupled. It is preferably in the form of flash memory. In a preferred embodiment, the non-volatile memory is removable/replaceable by a user. The storage device may, e.g., include an SD-card (or other memory card) slot for this purpose.

The host device interface on the storage device can be any suitable such interface via which a mass storage functionality can be provided (and is supported), i.e. that can allow a host device that the storage device is coupled to read data from and write data to the storage device. The host device interface is preferably a wired interface. Most preferably it is in the form of a male connector (i.e. such that the storage device is used by plugging it into a suitable port on a host device). In a particularly preferred embodiment, the host device interface is a USB interface, preferably in the form of a male USB connector.

In a preferred embodiment, the storage device can be powered via its host device interface (connector). Where power can be provided via the host device interface, there is then no requirement for an integrated power source in the storage device that is capable of fully powering the computing environment of the storage device. Thus, in one preferred embodiment, the storage device does not include an integral power source (such as a battery) capable of fully powering the computing environment of the storage device, but can be, and is, instead powered for this purpose via its host device interface. (This said, the storage device could have a small internal battery for powering and retaining an internal clock and state settings, and/or for allowing for safe shutdown, for example, if desired. However, the power required to fully operate the computing environment, for example, would be provided via the host device interface.)

It would also be possible, e.g., to provide an internal battery to act as a supplemental power source for when the current drawn by the computing environment in use exceeds the maximum current rating of the host device interface (a USB connection, for example, has a limited maximum current it can provide). In this case, if the instantaneous current drawn by the storage device exceeds the host device interface supply, the internal battery will be used to provide the additional current, but once the instantaneous current drawn falls below the level of the host device interface supply, that supply is then (preferably) used on its own to power the computing environment.

It would, of course, also be possible, if desired, to provide an internal battery on the storage device that is capable of fully powering the storage device. In this case the storage device could be used, e.g. with a display, without the need for any external power source.

Where the storage device includes an internal battery, that battery can preferably be charged via the host device interface.

The host electronic device that can be coupled to the storage device via its host device interface (and to which the storage device can provide a mass storage function) may be any suitable such device that can be coupled to and interface with the storage device. It could, for example, be an appliance such as a television, printer, washing machine, cooker, etc., or a personal computer. It may also or instead be a portable device, such as a phone, a camera, a portable entertainment device (e.g. music and/or video player and/or a gaming device), or a personal navigation system, or an in-car navigation and/or entertainment system.

The communications interface and protocol used between the storage device and the host device over the host device interface can take any suitable and desired form, e.g., depending upon the storage device and host device in question.

However, in a particularly preferred embodiment, a mass storage device interface and communication protocol (e.g. that is provided for normal “mass storage” use of a storage device) is used for some or all communication between the storage device and the host device via the host device interface of the storage device. In other words, the communications interface between the storage device and the host device via the storage device's host device interface is preferably such that when the storage device and a host device are coupled to each other via the host device interface of the storage device, the host device can act and (preferably always and automatically) acts as the master device (as the protocol master), and the storage device can act and acts as the slave device, i.e. (preferably only) the host device can schedule the configuration and data transfers over the host device interface and the storage device preferably cannot initiate and control data transfers but can only respond to requests from the host device.

In a preferred embodiment, the storage device uses an existing mass storage communications interface (an interface that supports mass storage access from a host device) and protocol such as, and preferably, an SD or USB interface, for communicating with a host device via the host device interface.

Thus, in a particularly preferred embodiment, communication between the storage device and a host device via the host device interface of the storage device can take place and takes place via a host device data file input/output (read/write) mechanism that is provided for the transfer of data to and from the memory on the storage device for a “normal” “mass storage” function. Thus, communication between the storage device and the host device via the storage device's host device interface preferably takes place as appropriate (read/write) file accesses (data transfers) by the host device to the storage device, i.e. by means of the host device acting as a “master” device reading and writing files from and to the storage device (which behaves as a slave device) preferably using a (the) conventional storage device mass storage function interface and protocol. In a particularly preferred embodiment, the communication from the storage device to the host device via the host device interface is achieved by the host device reading files (data) from the storage device, and communication from the host device to the storage device is achieved by the host device writing files (data) to the storage device.

This has the advantage that as such data transfer mechanisms will already be provided in any host and storage device system (for the purpose of storing data on and reading data from the storage provided on the storage device), the need to provide further communication arrangements and interfaces to provide operation for the present invention is avoided.

It also has the advantage that the normal “storage device” interface between the host and the storage device (where the host device acts as (and is) a master device accessing the “slave” storage device) can straightforwardly be maintained, such that, for example, the host device will continue simply to assume and act as if there is a (slave) storage device attached to it, and means that the present invention can be used with existing storage device systems.

Thus, the storage device is preferably configured such that when coupled to a host device via its host device interface, it presents to the host device as a (slave) mass storage device (rather than, e.g., as some other form of computing peripheral).

Other communications arrangements over the host device interface could be used as well (or instead), if desired.

The computing environment on the storage device can comprise any suitable and desired such environment. It should comprise at least an application processor (a processor for executing an application on the storage device).

The application processing part of the computing environment on the storage device can comprise any suitable and desired components and elements. It preferably includes a processing unit capable of performing calculations, graphics and other acceleration. It should comprise at least a micro-processor that is capable of executing the application or applications in question. In a preferred embodiment, the storage device has a general-purpose CPU for this purpose, but it may also or instead have a more dedicated processor, such as a graphics processor.

The application processor (the processor that can execute applications) of the computing environment can preferably act as a general computing device, e.g. it can preferably act as a fully programmable computing device which can be configured or programmed to handle any (multiple) desired (personal) computing task(s). The application processor is preferably able to support (process) real-time interactions with a user. For example, it is preferably able to execute at least an appropriate (modern) operating system (OS) with a graphical user interface (such as Ubuntu).

In one preferred embodiment there is a single application processor on the storage device (in the application processing part of the computing environment on the storage device). However, it would be possible for there to be plural application processors (which need not all be the same). Thus, in another preferred embodiment, the application processing part of the computing environment on the storage device includes plural application processors. Where plural application processors are provided, there is at least a CPU (or some other form of more general processor) and a graphics processor (GPU).

In a particularly preferred embodiment, the computing environment on the storage device comprises at least one CPU (or some other form of more general processor), and one or more of, and preferably all of, a graphics processor (GPU), debugging infrastructure, peripherals, power management, and clock control.

The processor(s) on the storage device should also have access to memory on the storage device (to allow them to run the application or applications, etc.). This may be, and in a preferred embodiment is, the same memory as the memory that is used for the mass storage function for a host electronic device when it uses the storage device for storage in the normal fashion, or there may also or instead be (further) memory that is provided specifically for the use of computing environment processor(s) on the storage device.

In a preferred embodiment, as well as the, e.g., normal non-volatile memory on the storage device, the computing environment includes a random access memory (RAM) that is useable by the processor(s) of the computing environment. This random access memory preferably serves, at least in part, as system memory for the computing environment on the storage device. Thus, the computing environment preferably includes both volatile and non-volatile storage (memory), including suitable system memory. The non-volatile memory may be fixed and/or removable, as desired.

In a particularly preferred embodiment, the computing environment of the storage device is operable to control, and controls, (all) access to and from the mass storage of the storage device via the storage device's host device interface. In other words, the computing environment preferably operates to provide the “normal” mass storage functionality of the storage device to the host device. Mass storage accesses from a host device can, e.g., be translated by the computing environment on the storage device into accesses to, e.g., flash storage. Access can, e.g., be granted or denied based on address range accessed, files accessed or other criteria.

Having the mass storage operation functionality provided by the computing environment is advantageous because it avoids the need to provide this separately and can make the storage device more flexible and allow the mass storage communications protocol's implementation and performance to be optimised.

This can be achieved in any suitable and desired fashion. For example, the computing environment may, and in one embodiment does, include a suitable mass storage (non-volatile memory) controller, such as a NAND or NOR flash device controller, or other controller that performs lower level access to a non-volatile storage device. It may also or instead include (execute) a suitable mass storage device driver, such as an SD-card controller driver.

In a preferred embodiment, where the computing environment executes an operating system that includes mass storage device drivers, this is then preferably used to provide the mass storage functionality to the host device. Indeed, it is an advantage of the present invention that this can remove the need to provide a separate higher layer mass storage controller on the storage device. (It will be appreciated here that there may still need to be a lower level, physical layer, hardware mass storage “controller” that feeds the data appropriately to the computing environment. However, any higher layer (level) mass storage processing is preferably then performed by the drivers in the operating system, rather than by a higher layer hardware controller, for example (although this could be provided, if desired.)

In a particularly preferred embodiment the computing environment also provides (supports) wireless connectivity between the computing environment and an external device. This may be via any suitable wireless communication protocol, such as GSM, 3G, 4G, LTE, and/or a suitable short-range wireless communication protocol, such as Wi-Fi and/or Bluetooth. In a preferred embodiment, the storage device has a short range wireless connectivity, such as, and preferably, Wi-Fi and/or Bluetooth connections.

This can allow, in particular, the computing environment on the storage device to access the Internet and Cloud resources, and/or for a suitably equipped wireless control device, such as a wireless keyboard, wireless mouse or a smart phone, to be used to control and interact with the computing environment of the storage device (and hence with an application running on the storage device) directly and in real-time. This facilitates, for example, allowing a user to install and execute appropriate applications on the storage device, for the storage device then to display via an appropriate graphical user interface on a display via its display interface.

Thus, in a particularly preferred embodiment, the storage device has wireless connectivity to allow its computing environment to access the Internet. This facilitates, for example, the storage device uploading and/or downloading data (files) to and/or from the Internet. In a preferred embodiment, downloaded data (files) are made available to the host device, by e.g., storing them in the mass storage of the storage device.

Similarly, in a preferred embodiment the storage device also or instead (and preferably also) has wireless connectivity to allow a wireless control device, such as a keyboard or mouse, to control the operation of the application processor on the storage device (of an application that is being executed on the storage device). By using such a wireless control device with the storage device coupled to a display via its display interface, a user can use applications on the storage device without, e.g., the need also to couple the storage device to any form of host device with computing resources (or for the display itself to have appropriate computing resources). Thus, the storage device can then, in effect, act as a form of portable computer in its own right.

The wireless connectivity that allows a wireless control device to control the operation of the application processor on the storage device may be configured in any suitable and desired manner. It may, for example, be configured to communicate with a custom-made wireless control device. However, in a particularly preferred embodiment, the wireless connectivity is instead configured to communicate with a (or any) standard (non-custom-made) wireless control device. This then removes to need to provide a custom-made wireless communication device along with the storage device for controlling the operation of the application processor on the storage device, and facilitates the provision of a “minimal” computer (a compact, small, portable, and cost-effective device), as discussed below.

The application that is to be executed on the storage device can be any suitable and desired application. Preferably, there are a plurality of applications that can be executed on the storage device. As well as an operating system, exemplary applications include games, productivity applications such as spreadsheets, presentation applications, and word processors, internet browsers, email clients, video, photo and audio editing tools, internet applications, user interface applications, etc. The applications, in many cases, are preferably able to support real-time interactions with a user.

The applications to be executed on the storage device may comprise third party applications that have not been written specifically for the storage device. Applications may be installed and/or deleted to and/or from the storage device as desired. This then facilitates a user to acquire and install applications as desired, and to thereby change the purpose and functionality of the (computing environment of the) storage device.

The code (and content) for the applications that are to be executed on the storage device should be stored in memory on the storage device that is accessible to the computing environment on the storage device. The application(s) may, for example, be stored in the “normal” memory (mass storage) that the storage device provides to a host device, or there may, e.g., be a separate memory that is provided for this purpose.

The display interface of the storage device may be any suitable such interface that can be used to couple the device to an external display (any suitable screen interface) and to thereby display graphical images generated by the computing environment on the storage device. It can be any interface suitable to connect to a TV or screen, for example, such as RGB, Coaxial, Scart, LVDS, etc. In a preferred embodiment the display interface comprises an HDMI, DVI or VGA, and preferably an HDMI, interface. It preferably is in the form of a wired connector. Most preferably the display interface of the storage device is in the form of the male connector for the display interface in question (e.g. a male HDMI connector), as that will then allow the storage device to be plugged directly into the corresponding port of a suitably equipped display (e.g. screen).

As well as providing a video output, the display interface preferably supports providing an audio output (via the display) from the storage device. Thus, where the display interface supports an audio output, preferably an audio output generated by an application that is being executed on the storage device can be output via the display interface for broadcast via a display to which the storage device is connected.

The provision of the display interface can facilitate, for example, allowing a user to control and interact with the computing environment of the storage device (and hence with an application running on the storage device) directly and in real-time, and for the storage device to display a graphical and/or audio output. This also removes the need to provide a custom-made and/or built-in display (or speakers, etc. for the storage device), and facilitates the provision of a “minimal” computer (a compact, small, portable, and cost-effective device), as discussed below.

Although as described above, a user can preferably interact with and control the computing environment on the storage device via a wirelessly connected wireless input device, in a particularly preferred embodiment the computing environment on the storage device can also or instead be accessed and controlled (by a host device) (in real-time) via the host device interface of the storage device, i.e. a host device can act as an input device for the computing environment via the host device interface of the storage device. This may be the only control access and input mechanism provided, but in a preferred embodiment is in addition to a wireless control and input connection.

Such control and inputs from a host device can include any type of data that can in any way control or be used by the computing environment or an application that is running in the computing environment of the storage device, such as user inputs like mouse movements, touchscreen gestures, key presses, speech, etc., or other sensor data such as gps coordinates, gyroscopic and accelerometer inputs, etc.

Such control of and input to the storage device by a host device via the storage device's host device interface may be achieved and provided as desired. In a particularly preferred embodiment it is done by configuring the operating system and/or another application or applications that is being executed on the storage device to access and use input functions (i.e. for the storage device to be able to use input functions), and preferably also output functions, of a host electronic device to which the storage device is coupled via the host device interface. Thus, in a preferred embodiment, the storage device and a host device can be, and preferably are, configured to allow the storage device (the operating system and/or another application running on the storage device) to use (real-time) input (and, preferably, output) functions of the host electronic device via the storage device's host device interface. (Where the storage device only accesses the host device's input functions, then it may provide its output (to the user) via the display interface instead.)

Allowing the storage device to use output functions of the host electronic device will allow a graphical output generated by the storage device (the operating system and/or an application running on the storage device) to be displayed via the host electronic device (e.g. via a display of or coupled to the host electronic device). In a preferred embodiment, the storage device (the operating system and/or another application running on the storage device) is configured to be able to and to display a graphical output via both the host electronic device (via the host device interface of the storage device) and via the display interface of the storage device (in the manner described above), preferably at the same time. The storage device could, for example, display the same graphical output via both the host electronic device and the display interface, or it could display two different graphical outputs.

The storage device and a host device can be configured to allow the storage to use input (and, preferably, output) functions of the host electronic device via the storage device's host device interface in any suitable and desired manner. However, where, as discussed above, the storage device's host device interface is configured as a mass storage interface in which the storage device acts as a slave device, then the Applicants have recognised that it will be necessary for the host device to, in effect, “push” user inputs to the storage device (as the master host device controls all data transfer across the host device interface). Thus, in a preferred embodiment, the host device is configured to push (relay) user input actions and functions to the storage device's computing environment over the host device interface. The host device's operating system may, e.g., be configured to do this, or, e.g., an application may be provided on the host device for relaying user inputs, etc., to the storage device.

In a particularly preferred embodiment, the storage device and the host electronic device are provided with a server module and a corresponding client module, respectively. The server module on the storage device preferably allows the storage device to control input (and output, where supported) functions of the host device via the client module on the host device. The client module on the host device is preferably operable to interface with the storage device and to use the input (and output) functions on the host device on behalf of the storage device. In this way, the respective server and client modules can allow the operating system, and/or an application, etc., that is running on the storage device to be accessible via and to use input (and output) functions of the host electronic device.

Thus, in a particularly preferred embodiment, the storage device comprises a server module operable to interact with a corresponding client module on a host electronic device via the host device interface of the storage device, so as to allow the operating system and/or an application running on the storage device to use input (and preferably also output) functions of the host electronic device (i.e. to allow input functions of the host device to be used to input commands and data to the computing environment on the storage device (to allow a host device to act as an input device for the computing environment on the storage device) (and, preferably, also to allow output functions of the host device to be used to provide user outputs from the computing environment on the storage device (to allow a host device to act as an output device for the computing environment on the storage device). Similarly, the method of the present invention preferably includes using a server module on the storage device to interact with a client module on a host electronic device to allow the storage device to use input (and output) functions of the host electronic device via the host device interface of the storage device.

It should be noted here that these arrangements of the present invention will be such that the operating system and/or an application, etc., is executed in the computing environment on the storage device, and the storage device then acts as a “master”, controlling slave input (and output) functions on the host electronic device (which is therefore a “slave” to the “master” application, etc., on the storage device). This should be contrasted with, for example, the situation where a storage device may store application code for a given application, but the application is then executed on the host electronic device. (However, the data transfer between the host device and the storage device via the host device interface will still have the host device as the “master”, as discussed above, it is just that it is the storage device that is in effect, controlling the input (and output) functions of the host device, and so acting as the “master” of those host device functions.)

The client module on the host electronic device and the server module on the storage device can be provided and configured in any appropriate fashion. They are preferably provided by means of appropriate client and server, respectively, software that is running on the respective devices.

Where, as will be discussed below, the storage device includes both an application processor and an interface processor, then the server module on the storage device may, e.g., be run on the application processor or on the interface processor, or distributed across both the application processor and the interface processor. In a particularly preferred embodiment it is run on the interface processor (i.e. the interface processing part performs the server functions on the storage device). This, inter alia, avoids burdening the application processor with the need to run the server module.

The input and output functions of the host device that can be used by an application that is running on the storage device can include any suitable such functions. Thus they may, and preferably do, include, input functions such as a key pad, touch screen and/or audio input, and outputs such as a screen and/or audio output. Preferably all of the available input and output functions of the host device can be used by an application that is running on the storage device.

In a particularly preferred embodiment, an application running on the storage device can interact with and make use of other functions of a host electronic device via the host device interface. In a preferred such arrangement, an application running on the storage device can use the network connections of the host device in order for applications running on the storage device to access the

Internet. Other functions of a host device that it may be particularly desirable to use are resources that generate and/or collect data that may be useful to an application, such as GPS functions, sensor functions, a microphone, a camera, and a video decoder/encoder, etc., of the host device.

As will be appreciated by those skilled in the art, in these arrangements where there can be communication between input and/or output functions of a connected host device and the computing environment of the storage device via the storage device's host device interface, then the communication between the storage device and the host device could comprise, e.g., the sending of commands, content and/or other data to the host device (e.g. to the client module on the host device) and vice-versa. For example, data to be sent from the host device to the storage device may comprise, e.g., all data relating to key presses, audio, video, gps, sensor inputs, etc.

The actual data that is communicated will depend on the application that is running on the storage device. For example, in the case of an, e.g., mapping application, key presses, internet traffic (streaming maps) and gps co-ordinates could be sent to the application on the storage device, which would then process the data and provide image data back to the client host device.

Similarly, data to be sent from the storage device to the host device preferably comprises at least image data (for display) but could also comprise audio data for example. In other applications it could comprise GPS data (where the storage device incorporates a GPS function) or network data (where the storage device incorporates a network function), for example.

As discussed above, in a particularly preferred embodiment of the present invention, an existing storage device mass storage interface and communication protocol (i.e. that is provided for normal “mass storage” use of the storage device) is used for communication between the storage device and the host device via the host device interface of the storage device and the host device acts as the master device controlling and initiating the communication and data transfers over the host device interface with the “slave” storage device.

Thus, in a particularly preferred embodiment, communication between the operating system, and/or another application, running on the storage device and the host device (e.g. between the server and client modules on the storage device and the host device, respectively), via the host device interface of the storage device takes place via the data file input/output (read/write) mechanism that is provided for the transfer of data to and from the memory on the storage device for its normal “mass storage” function. Thus, communication between the storage device and the host device via the storage device's host device interface preferably takes place as appropriate (read/write) file accesses (data transfers) by the (master) host device to the (slave) storage device, i.e. by means of the host device (e.g. the client on the host device) reading and writing files from and to the storage device using a (the) conventional storage device mass storage function interface and protocol. Preferably all communication between the operating system, and/or another application, running on the storage device and the host device (e.g. between the server and client modules on the storage device and the host device, respectively), via the host device interface of the storage device takes place via the data file input/output (read/write) mechanism that is provided for the transfer of data to and from the memory on the storage device for its normal “mass storage” function.

(Thus, the communication from the storage device to the host device is preferably achieved by the host device reading files (data) from the storage device, and communication from the host device to the storage device is preferably achieved by the host device writing files (data) to the storage device.)

The files (data) that are read and written may comprise commands, content or other data, as appropriate. They are preferably seen as generic data transfers by the host device, with the server or client module (if provided) then interpreting the data transfers (the content of the data transfers) as being commands, content or other data, as appropriate and as necessary.

The Applicants have recognised that in these aspects and arrangements, there may be a need for a mechanism to distinguish between normal data file input/outputs to and from the storage device (i.e. that are for the purpose of storing data on or reading data from the storage device in the normal “mass storage” manner) and those inputs and outputs that relate to the operation of an application that is running on the storage device (when the storage device is acting as a master controlling slave functions on the host device) and/or control of the storage device by a host device.

Most preferably, a “normal” mass storage data input and output can be identified (which results in the standard storage device behaviour (i.e. reads and writes to the mass storage on the storage device)), an input that is in fact a communication sent from the host device acting as a slave to an application running on the storage device can be identified (which results in that input being provided, e.g. to the server module on the storage device for processing (which server module can in turn then provide the interpreted input to the appropriate resource in the application) (rather than it simply being stored in the memory of the storage device)), and an output that is in fact a communication from the, e.g. server module, on the storage device to, e.g. the client module, on the host device can be identified.

Any suitable mechanism can be used to distinguish and identify these different types of communication. In a particularly preferred embodiment, it is done by using the addresses associated with the reads and writes being performed. (In the case of an SD card, for example, data is transferred in blocks (typically of 512 bytes), and each block has a “block address” associated with it.) Preferably certain data addresses (e.g. block addresses) are associated with “normal” data transfers (such that reads and writes to those addresses result in normal storage device “mass storage” behaviour), and other addresses are associated with (set aside for) the respective input and output communications when an application, etc., is being executed on the storage device. Then by causing the host device to write data to and read data from the appropriate addresses, communication between an application, etc., running on the storage device and the relevant functions on the host device can be facilitated.

Thus, in a particularly preferred embodiment, communication from the host device to or for an application, etc., that is running on the storage device is achieved by the host device writing data to a memory address or addresses that has been set aside for (associated with) such communication, such that when the, e.g., server module on the, storage device sees that data is being written to that address, it can identify that data as being a communication that needs to be processed for or provided to the application, etc., in question. (The data that is written to the address may comprise, as discussed above, e.g. commands, content or other data for the server and/or application(s).)

Similarly, in a particularly preferred embodiment, communication from an application, etc., that is running on the storage device to the, e.g. client module of the, host device is achieved by host device reading (e.g. by the client module causing the host device to read) from a memory address or addresses that has been set aside for (associated with) such data transfers, such that when the, e.g. server module on the, storage device sees the host device attempting to read such an address or addresses, it can return the appropriate communications to the host device. (Again, the data that is returned in response to the read may comprise, e.g., commands, content or other data for the, e.g. client module on the, host device.)

Thus, in a particularly preferred embodiment, the host device, in order to transfer data and/or commands from the host device to the storage device via the host device interface, writes data to the storage device to an “input” address or addresses that has or have been predefined as being an address or addresses to be used for this purpose.

Similarly, the host device, in order to receive communications (data) that is intended for it from the storage device via the host device interface, reads data from an “output” address or addresses on the storage device that has or have been predefined as being an address or addresses to be used for that purpose. The storage device then recognises such reads and transfers the appropriate data, etc., to the host device in response thereto. The host device will know that any read it does from an output address should contain data, etc., that is for it.

In a preferred arrangement of these aspects and embodiments of the invention, the particular “input” and “output” address arrangements are achieved by defining special files in the address area of the storage device, a predefined “output” file or files from which communications for the host device can be read and a predefined “input” file or files to which communications from the host device for the storage device should be written. Then, the host device can communicate with the application on the storage device by reading an “output” file and writing to an “input” file, as appropriate. Such files may be created, for example, by manipulating the file access tables and directory tables for the storage device. There may be a single “output” and a single “input” file defined, or there may be plural input and/or output files.

It is preferred that these arrangements do not interfere with the normal mass storage operation of the storage device. Thus, there is preferably a set of addresses (a range of addresses) (an address space) that is used and set aside for the normal mass storage operation. Most preferably the input and output addresses used for other host/storage device communication are not in the address space of the mass storage part of the storage device (they may, in effect, be “virtual” addresses that do not physically exist in the mass storage part of the storage device).

Then, if the host device reads or writes to an address that is in the address space of the mass storage operation, the storage device will allow that operation to proceed as normal (as for the normal mass storage function of the storage device), but if the host device reads from or writes to an output or input address, the storage device is configured to recognise that and act accordingly (in the case of a write to an input address, to, e.g., send the data being written to appropriate functions in applications that are running on the storage device, and in the case of a read from an output address to provide any desired data to, e.g. the client module of, the host device). It is similarly accordingly preferred that any files (data) to be transferred to the, e.g. client module on the, host device from the, e.g. server module of the, storage device are not stored in the normal mass storage area (e.g. non-volatile memory) provided on the storage device (although this could be done if desired), but are instead stored elsewhere on the storage device, for example and preferably in RAM, and/or otherwise buffered, on the storage device.

It will be appreciated that by means of these arrangements, the host device is able to operate in its normal fashion with respect to the storage device, namely simply to read or write files from and to specific addresses in accordance with the mass storage device format and protocol (e.g. for SD cards in the form of blocks of data with an SD specific protocol). However, the storage device (e.g. via its server module) can then identify, interpret and process the communication in question based on the address being read or written to. Thus, in effect, the host device is able to act as if it is simply reading and writing generic data in the normal fashion, with the storage device then identifying data for the other operations (e.g. for server/client operation) based on the addresses used. For example, if the data is written to an address that is set aside for communications to the server module, the server module will interpret and process that data accordingly.

It will be appreciated that in these arrangements, in order for the, e.g. server module on, the storage device to communicate to the, e.g. client module on the, host device, the host device must read the relevant data (file) from the storage device. This may be achieved as desired. In a preferred embodiment, the host device is configured to read the relevant addresses (file(s)) periodically (i.e. to, in effect, “poll” the storage device periodically). This will ensure that the host device receives any communication for it from the storage device at least at a minimum rate. The reading (polling) may take place at a fixed rate (at a fixed timing) or it could be varied (at a dynamic timing), e.g. depending on the application and circumstances in question. The client module or other application on the host device may be configured to cause the host device to operate in this way, for example.

The Applicants have further recognised that in systems where a host device operates to cache data that is read from a storage device, then such caching operation could interfere with this operation of the present invention. In particular, if the host device preferentially reads from its cache if it believes that it has the data already stored in its cache (e.g. from a previous read of the same memory address) (which is typical host device operation, as there is an assumption that the data stored on a storage device will be static), then the host device could fail to read data from the storage device if it thinks it has already read and cached data from the read address in question. In other words, there could be a risk that changes in the “output” file (for example) on the storage device would not be picked up by the host device, because the host device, if instructed to read from the output file (the output address(es)) again, will instead read from its cache (such that the read will not go back to the storage device), and thereby fail to pick up the new output file from the storage device.

In a particularly preferred embodiment therefore, steps are taken to help alleviate, and preferably to avoid, the possibility of this problem arising. In the case of a host device whose caching operation can be disabled, the host device (e.g. via its client module) is preferably configured to turn off the caching operation of the host device when operation in this manner of the present invention is required.

If this is not possible, and/or as an alternative, the relevant output data (output file(s)) storage and reading process is preferably configured in such a way so as to tend to trigger cache “misses” on the host device (to thereby force the host device to read from the storage device itself, not simply from its own cache). This may be, and in a preferred embodiment is, achieved by arranging the output data (file(s)) for the host device to read to be bigger than the size of the cache (such that the host device cannot keep all the data in its cache at once) and configuring the host device to read the output data (from the output file) in a random order (so the host reads to a random position in the output data (file)). This should have the effect that any data to be read by the host device will tend to not be present in the cache, thereby triggering a cache “miss” and forcing the host device to read from the storage device itself.

In a particularly preferred embodiment, the host device is also or instead, and preferably also, configured to acknowledge data transfers that it receives from the storage device when an application, etc., is being executed on the storage device, and/or when the host device is being used to control the computing environment of the storage device via the host device interface. This then allows the storage device to identify whether the host device has received the data transfer or not. This provides another mechanism for ensuring that the host device has received all of the data to be transferred.

Most preferably, the storage device continues to provide the same data to the host device when the host device attempts to read data from the storage device in use, until it receives the appropriate acknowledgement from the host device. In other words, the storage device preferably keeps resending the same sequence of data to the host device until it receives an acknowledgement that that data has been successfully received. This again helps to ensure that the data transfer has been completed correctly. Thus, for example, if the storage device is to send a sequence of four data packets to the host device, if it does not receive an acknowledgement after sending the fourth packet, it starts again at the first packet in the sequence, rather than starting a new data transfer, when it receives the next read from the host device.

Such acknowledgements could be provided as desired. For example, the host device could be configured to send an acknowledgement message, e.g. in the form of a flag included with a data transfer, to the storage device once it has correctly received a data transfer.

In a preferred embodiment, an implicit acknowledgement mechanism is used, whereby some other action of the host device also has the effect of implicitly acknowledging the data transfer to the storage device. This has the advantage of avoiding the need for the host device to send an explicit acknowledgement message to the storage device, thereby saving bandwidth.

Preferably such an implicit acknowledgement is given by the host device attempting to read a different output address (an address from a different output address range) on the storage device, with the storage device then interpreting the fact that the host device is now reading a different output address (or address range) as being an acknowledgement that the previous output address read has been successfully completed.

Thus, in a particularly preferred embodiment, there are two (or more) defined data address ranges (e.g. block address ranges) that are associated with (set aside for) data transfers from an application that is running on the storage device to the host device, and when the host device has successfully read a data transfer from one of the predefined address ranges, it then triggers the host device to read from another of the predefined output address ranges, with the storage device then taking the change in output address range being read as an acknowledgement that the previous output address read has been successfully completed.

Such output address arrangements are preferably again achieved by defining two (or more) “output” files, each associated with a different address range, with the host device switching between reading the respective output files when it wishes to acknowledge safe receipt of a data transfer.

In a particularly preferred embodiment, the data transferred between the host device and the storage device for this operation (i.e. when the host device is being used as an input device (or as an input and output device) for the storage device (for an application, etc., that is being executed in the computing environment of the storage device) is sent in the form of, preferably fixed size, discrete data units or packets. Preferably each such packet is an appropriate size for the storage device system in question. Thus, in the case of an SD card, for example, the data is preferably organised as and sent in the form of packets, each of which will fit into one 512 byte SD block.

Where, as may typically be the case, the host device is operable to read a batch of data comprising more than one packet (e.g. block) from the storage device each time it reads data from the storage device, then the storage device preferably groups data to be transferred to the host device in appropriately sized batches for the host device to read. If necessary, the storage device may pad the data batches with dummy data packets (dummy blocks), for example where there are no, or not enough, “real” data packets to be sent in response to a read by the host device.

Where the data transfers from the storage device to the host device are organised in this fashion, then preferably each individual data packet (e.g. data block in the case of a block-based data transfer system (such as would, for example be the case with an SD card) within the batch is uniquely numbered (preferably in an increasing sequence). This then allows each data packet in the batch to be identified.

The host device (e.g. its client module) preferably then checks the identification number of a packet which it receives to see if it has already processed that packet and if it has, discards the packet and send another read request (as if it receives a packet it has already seen, that could be because the read has come from the host device's cache, not the storage device).

In a particularly preferred embodiment, each data packet also indicates the size of the data batch (in terms of the numbers of data packets it contains) to which the data packet belongs. This further helps the host device to determine if it has received and processed a data batch from the storage device correctly or not. Preferably, where an acknowledgement mechanism, as discussed above, is provided, the host device is configured to send an acknowledgement when it has received a complete batch correctly (rather than, for example, acknowledging each data packet individually).

The data packets preferably have a particular, preferably predefined, format. A different format may be, and in a preferred embodiment is, used for packets to the (slave) host device and for packets from the (slave) host device. For example, packets from the storage device for the host device preferably include a packet identification (sequence number) and an indication of the number of packets in the batch in question, as discussed above, whereas this is not necessary for packets that are being sent from the host device to the storage device (but such packets are in a preferred embodiment able to carry an acknowledgement, as discussed above).

In the arrangements of the present invention where a host device is to be used as an input and/or output device via the host device interface for an application that is being executed in the computing environment of the storage device, then data and commands, etc., will need to be communicated in an appropriate form or forms from the application processor on the storage device to the host device and vice-versa.

The Applicants have recognised that there could be situations where the form of data and commands that will be used for communication between the host device and the storage device may not be the same as the form of data and commands that will be required by the application running on the storage device, and vice-versa. Thus, there may be a need for the communication (e.g. data and commands) between the host device and storage device to be, in effect, converted or “translated” for communication appropriately to the application that is being executed, and vice-versa.

Where such translation is required in the present invention, then it can be carried out in any suitable and desired manner. For example, any necessary communications interfacing and translation could be carried out on the application processor itself (e.g. by means of suitable software running on the application processor) or on the host device (e.g. by means of suitable software running on the host device).

In one preferred embodiment, any necessary communications interfacing and translation is carried out on the application processor itself (e.g. by means of suitable software running on the application processor). In this case, the computing environment on the storage device will comprise an application processing part comprising at least one application processor for executing the application on the storage device, and for interfacing between the application processor and the host device. The application processor preferably also executes the server module (if provided) of the storage device.

In another particularly preferred embodiment of the present invention, the computing environment on the storage device comprises an application processing part comprising at least one application processor for executing the application on the storage device, and an interface processing part comprising at least one interface processor that is separate to the application processor, for interfacing between the application processor and the host device, the computing environment being configured such that communication between the host device and an application that is being executed on the application processor via the host device interface takes place via the interface processor.

Similarly, in a particularly preferred embodiment, the method of the present invention comprises using an application processing part of the computing environment on the storage device comprising at least one application processor for executing the application on the storage device, and using an interface processing part of the computing environment on the storage device comprising at least one interface processor that is separate to the application processor for interfacing between the application processor and the host device, such that communication between the host device and an application that is being executed on the application processor takes place via the interface processor.

In these embodiments of the present invention, the computing environment on the storage device accordingly includes both an application processor for executing the application itself, and a separate interface processor (i.e. in addition to and separate from the application processor(s)) for interfacing between the application processor and the host device (i.e. for handling data and instruction communication between the host device and the application processor via the storage device's host device interface).

By carrying out the communication interfacing and translation on a separate interface processor on the storage device, the burden of that processing is removed from the application processor on the storage device. Similarly, it avoids the need to make any hardware or software changes for this purpose on the host device.

Using a separate interface processor in this manner can also, e.g., enhance the flexibility and scaleability of the system and provide other advantages.

The interface processing part of the computing environment (where provided) can be configured in any suitable and desired manner, and take any suitable and desired form. It should at least comprise a processor (which may be a CPU, dedicated hardware, etc., as desired) operable to interface (translate) between a communications protocol used between the host device and the storage device, and a communications protocol required or expected by an application being executed on the application processor. It should also have appropriate communications interfaces to the host device and to the application processing part of the computing environment on the storage device, such that communication between the host device and an application that is being executed on the application processor can take place via the interface processor.

The interface (translation) function, e.g. of the interface processor, should be operable to take data received from the host device and convert it to the appropriate data structures that the application processor(s) uses, and vice-versa.

In a preferred embodiment, the interface function, e.g. interface processor, as well as being able to convert data between the protocol required for communication with the host device, and the protocol required by application processing element, is also able to encode and/or compress data to be sent to the host device. It can preferably also or instead, and preferably also, encode and/or compress data sent from the host device. This will then reduce the data transfer requirements for sending data to the host device (and/or for sending data received from the host device), and accordingly reduce power usage, for example.

In these embodiments of the present invention, the communications interface of the interface function, e.g. of the interface processing part, between the interface function (e.g. interface processing part) and the host device can take any suitable and desired form, e.g., depending upon the storage device and host device in question. As discussed above, it is preferably the normal interface that the host device would have with the storage device. Thus, in a preferred embodiment, the interface processing part (where provided) includes a mass storage communications interface (an interface that supports mass storage access from a host device) such as, and preferably, an SD or USB interface, for communicating with the host device.

In this arrangement, the interface function, e.g. interface processor, accordingly preferably translates between the application processor and the data protocol used between the storage device and the host device.

Where the computing environment includes a separate interface processing part, the communications interface between the interface processing part and the application processing part of the computing environment on the storage device could, e.g., comprise a direct interface (connections) between the interface processing part and the application processing part. However, in a particularly preferred embodiment, at least in the case of data communication, communication between the interface processing part and the application processing part takes place via shared memory, as opposed to any form of direct connection. This is advantageous from a hardware perspective and may also, e.g., facilitate enhanced security.

Enhanced security arrangements facilitated by this could comprise, for example (and in preferred embodiments do comprise), making application code running on the application processing part not accessible to the interface processing part; in the case of graphics applications sharing only the frame buffer from (generated by) the application processing part with the interface processing part (and keeping all application code and application data inside memory areas only accessible by the application processing part); and/or limiting the interface processing part (e.g. by hardware features and/or by software features) to only have access to the shared memory (with all other system memory only being accessible by the application processing part). Preferably, the application processing part processor (e.g. CPU) has full control of what data leaves the storage device, and the interface processing part is limited (by hardware or software) to only have access to the shared memory region, and not to any of the application data or dynamic data used by the application processing part.

Thus, in a particularly preferred arrangement of the above embodiments of the invention, there is no direct data communications connection between the interface processing part and the application processing part of the computing environment, and the interface processing part includes appropriate elements and functionality for communicating with the application processing part via shared memory (and the application processing part correspondingly includes appropriate elements and functionality for communicating with the interface processing part via shared memory). Thus, the interface processing part preferably accesses data structures stored by the application processing part in a shared memory to receive communications from the application processing part and vice-versa.

Thus, in a particularly preferred embodiment, the interface processing part is operable to fetch data structures that have been written to shared memory by the application processing part, and to process those data structures into a form suitable for transfer to the host device. Similarly, the interface processing part is preferably operable to process data structures received from the host device into a form suitable for transfer to the application processor and to write those data structures to shared memory for use by the application processing part.

Thus, in a particularly preferred embodiment of these arrangements of the present invention, the computing environment on the storage device also includes memory (shared system memory) that is to be and that is shared by the application processing part and the interface processing part, and that is used by the application processing part and the interface processing part to communicate with each other.

Thus, the interface processing part of the computing environment on the storage device in these embodiments of the present invention is preferably connected to a shared memory and to a shared bus infrastructure, so that the application processing part can access internal components and/or functions of the interface processing part, and the interface processing part can access components/peripherals and/or functions of the application processing part.

In these embodiments of the present invention, as well as communicating via a shared memory (or otherwise), in a particularly preferred embodiment, an interrupt mechanism is provided between the application processing part and the interface processing part of the computing environment on the storage device, to facilitate (trigger) communication between the application processor and the interface processor and vice-versa. This interrupt mechanism may then be used, e.g., to cause the application processor to respond to inputs from the host device that have been processed by the interface processor (and, e.g., placed in the shared memory).

The interface processing part accordingly preferably includes an interrupt controller, which interrupt controller is preferably coupled to all the interrupt sources of the application processing parts, and/or all the internal interrupt sources of the interface processing part.

Interrupts from the application processing part to the interface processing part can be carried out in any suitable and desired manner. In one preferred embodiment all the application processor interrupts are available on the interface processing part interrupt controller.

In another preferred embodiment, the application processor interrupts are also or instead handled by the application processor interrupt controller, with interrupts needed for the interface processing part being raised by writing to an interface processing part register.

It would also or instead be possible, e.g., to have an extra interrupt controller in the application processing part that groups all interrupts to the interface processing part, and makes all application processing part interrupts available to the interface processing part.

The interface processing part corresponding preferably has the ability to interrupt the application processing part via an interrupt signal exiting from the interface processing part.

Other arrangements would, of course, be possible. For example, there could be only a single interrupt line from the application processing part to the interface processing part and vice-versa.

It would also be possible to operate the system without having dedicated interrupts between the application processing part and the interface processing part, if desired, and to use other communications mechanisms between the application processing part and the interface processing part of the computing environment. For example, the application processing part and the interface processing part could be configured to poll or otherwise periodically check a specific part of the shared memory for information about new data (communications) to be delivered to or retrieved from the shared memory.

Where the interface processing part includes separate controller components (such as an SD controller, a flash controller, etc.) inside the interface processing part, then the application processing part can preferably access these components over a shared bus. Access from the application processing part to these components is preferably controlled by the interface processing part.

In a particularly preferred embodiment of these arrangements of the present invention, the interface processing part is operable to control, and controls, access to and from the mass storage of the storage device via the storage device's host device interface. In other words, the interface processing part preferably operates to provide the “normal” mass storage functionality of the storage device to the host device. As discussed above, mass storage accesses from a host device can, e.g., be translated by the interface processing part of the computing environment on the storage device into accesses to, e.g., flash storage. Access can, e.g., be granted or denied based on address range accessed, files accessed or other criteria.

As discussed above, this can be achieved in any suitable and desired fashion. For example, the interface processing part may include a suitable mass storage (non-volatile memory) controller, such as a NAND or NOR flash device controller, or other controller that performs lower level access to a non-volatile storage device. The interface processing part preferably includes (executes) a suitable mass storage device driver for this purpose. (As discussed above, in this case there may still need to be a lower level, physical layer, hardware mass storage “controller” that feeds the data appropriately to the computing environment. However, any higher layer (level) mass storage processing is preferably then performed by the driver(s) in the interface processing part, rather than by a higher layer hardware controller, for example (although this could be provided, if desired).

Having the mass storage operation functionality on the interface processing part is advantageous because it avoids the need to provide this separately or via the application processing part of the computing environment. It also means that where the system is to be operated in a “storage device” (e.g. memory card) only mode, there is no need to use the application processing part (or, indeed, even to boot the application processor(s)), thereby saving on power, and potentially allowing faster boot times, for example, for mass storage device operation. Thus, in a particularly preferred embodiment the interface processing part is able to provide the mass storage functionality without the application processing part.

Preferably, the interface processing part controls access to and from data storage (whether the mass storage or otherwise) on the storage device. Most preferably, all access to at least the mass storage on the storage device is controlled by the interface processing part (and preferably in respect of accesses by both the host device and by the application processing part to that storage).

This has the effect that all access to the mass storage, for example, on the storage device requires permission of the interface processing part, such that the interface processing part accordingly can act as a firewall between the host device and the mass storage on the storage device, and/or between the application processing part and the mass storage on the storage device. This can enhance the security of the system, for example by preventing malicious code from being transferred from a host device to the application processing part and vice-versa.

Thus, in a particularly preferred embodiment, the interface processing part controls access by the application processing part to areas of the mass storage (flash memory) on the storage device, and/or (and preferably also) controls access by the host device to areas of the mass storage (flash memory) on the storage device.

In a preferred embodiment, the interface processing part is operable to (and preferably does) scan any incoming and outgoing data, thereby to add a layer of security to the operation (by means of the data scanning). This scanning could be used, e.g., to try to identify, and then block, any unwanted, forbidden and/or restricted, etc., data entering or leaving the storage device. Unwanted data could comprise, for example, attempts to inject malicious code into the storage device system. Forbidden or restricted data could comprise, e.g., copyrighted data that should be prevented from leaving the storage device.

As will be appreciated by those skilled in the art, in order to be able to operate in the full manner of the embodiments of the present invention where the computing environment on the storage device includes both an application processor and an interface processor, it will be necessary to enable (boot) both the application processor(s) and the interface processor(s) appropriately.

While it would be possible to enable (boot) both elements together (e.g. at power up), in a particularly preferred embodiment, the interface processor can be enabled (booted) independently of the application processor(s). Most preferably the interface processor is operable without the application processor(s) being enabled (booted). This then has the advantage that where the application processor(s) is not needed, e.g., because the host device simply requires mass storage operation and the interface processor alone is needed for (supports) that, then the application processor does not need to be enabled, thereby saving power, etc.

Thus, in a particularly preferred embodiment, if the host device only wishes to access the mass storage functionality of the storage device, only the interface processor is enabled (booted).

This also means that the storage device can still be used as a normal storage device with host devices that are not enabled to interact with applications being executed by the application processor of the storage device.

In a particularly preferred embodiment, the system is configured so as to only enable (boot) the interface processor on the storage device at power up. This helps to ensure lower power usage. This is preferably further helped by only running a minimum of components at power up. Preferably the interface processor runs at a lower clock frequency until it receives a request for more performance, at which point it may then increase the clock frequency, control the power controller, etc., to provide increased performance. Thus, in a preferred embodiment, the interface processor can vary the clock frequency at which it is operating. Requests for more performance could, e.g., be initialised from the host device running a (software) client requesting more functionality, and/or automatically by the interface processing part based on the host device's ability to provide power to the storage device, or other criteria.

For example, once the boot code on the boot ROM has been executed, the interface processor preferably then checks the authenticity of any further boot data and code stored in the mass storage memory of the storage device, and then proceeds (or not) to boot using that data and code stored in the mass storage memory of the storage device depending upon the result of the authentication check.

The authentication check could be carried out in any suitable and desired manner, for example by comparing an authentication key (or a value derived from an authentication key (such as a hash)) that is stored in secure storage accessible only to the interface processor with a corresponding key stored with the boot data and code in the mass storage memory of the storage device (or with a corresponding value, such as a hash, derived from a key stored with the boot data and code in the mass storage memory of the storage device).

Preferably, there is a further authentication check as the boot procedure continues using the data and code stored in the mass storage memory of the storage device, for example at an appropriate next boot code level. Again, this authentication check preferably comprises an appropriate comparison of an authentication key (or value derived from that key) stored with the boot data and code in the mass storage memory of the storage device with an authentication key (or value derived from an authentication key) stored in secure storage accessible to the interface processor, and again the boot procedure is preferably either continued or is aborted depending upon the result of that authentication check.

Accordingly, the interface processing part of the computing environment preferably includes some secure storage for storing the authentication key(s) (or values derivable from authentication key(s)) to be used to secure the boot procedure.

In a preferred embodiment, it is also possible to boot the system using boot code and data (a boot image) that is stored on an external storage device. This may be used, for example, to, in effect, boot the interface processor from a rescue image stored on an external storage device and/or as a procedure for loading the necessary boot code and data into the mass storage memory of the storage device for use for booting the interface processor when the system is started for the first time (i.e. for booting an empty system).

In this case, again the procedure is preferably that the interface processor is first booted from the boot ROM, and then, once it has started to boot, the interface processor preferably checks the authenticity of the stored boot image on the external storage device (which authentication procedure may again be, and is preferably, carried out by comparing appropriate authentication keys or key values).

In this case, if the authentication check is passed, the interface processor preferably then executes the boot code and data stored on the external storage device to continue booting the interface processor (e.g., and preferably, in the manner discussed above). It could, e.g., execute the boot code and data directly from the external storage device, or it could, e.g., load the boot code and data from the external storage device to the mass storage memory of the storage device, and then execute that boot data and code from the mass storage memory of the storage device to continue booting the interface processor (e.g., and preferably, in the manner discussed above).

In these arrangements, the interface processor will accordingly be enabled on its own. The application processor is preferably then enabled (booted) at a later time, preferably in response to (and preferably only in response to) some event that indicates a need for the application processor. The triggering event may, e.g., be, and preferably is, an appropriate user input on a connected host device, such as the activation of a client application on the host device, or an input via a (wirelessly) connected input device. In response to this, the system will then start to boot the application processor on the storage device. The application processor is preferably booted by means of the interface processor giving the relevant mass storage boot address to the application processor.

Thus, in a particularly preferred embodiment, the computing environment on the storage device is enabled (booted) in two stages, firstly (at power up) to a mass storage operation mode by booting the interface processor only, and, if required, then, in a second, subsequent stage, to a full application processing mode by booting the application processor(s).

In a preferred embodiment, the storage device is configured such that it will only enable (boot) the application processor if an appropriate host device or power source that can provide the necessary power, performance, etc. to support such operation is connected to the host device interface. (This could be determined, e.g., by data communication using the low level SD or USB protocols (the SD and USB protocols, as is known in the art, exchange information about the power available from the host device and also the requirements from the storage device).)

The interface processor is preferably also configured to handle any necessary initialisation and handshaking with the host device.

An advantage of the embodiments of the present invention that use a separate interface processor is that they facilitate the use of application processors for executing applications on a storage device coupled to a host device without the need for significant changes or modifications to the application processor itself (and, indeed, in preferred embodiments at least, require minimal, if any, changes or additions to the application processor(s)). However, the present embodiments do not preclude there being some changes or additions to the application processor, for example where that may be advantageous or required to allow the system to operate. Thus, for example, where appropriate, it is preferred to provide and execute a driver for the interface processor on the application processor(s), to allow the application processor to drive the interface processor (and the present embodiments encompass such arrangements).

It can be seen from the above, that in a preferred embodiment of the present invention, the computing environment, and most preferably the interface processing part of the computing environment, on the storage device is capable of one or more, and preferably all of, the following functions: transfer of data between an outside host and an application processor; memory card mode handling; initialization of the application processor; initialization and handshaking with the host device; and providing the nonvolatile mass storage device functions to a host device via the host device interface of the storage device.

Similarly, in a particularly preferred embodiment, the computing environment, and most preferably the interface processing part in the computing environment, on the storage device can and preferably does include one or more and preferably all of the following devices: a CPU or other controller able to control the components of the computing environment (e.g. interface processing part); an external interface controller to a host device (this can be, for example, SecureDigital, USB or other interface supporting mass storage access from a host device); a non-volatile memory controller (this can, e.g., be a NAND flash device controller, NOR flash controller or other controller that performs lower level access to a non-volatile storage device); some internal system memory (for use as working space memory); a debugging infrastructure (such as jtag, uart etc.); a component for compression and encoding of video, audio or data; a boot ROM for booting of the system and storing application code; an interrupt controller with connection to some or all of an application processor(s) interrupt sources and internal interrupt sources; and some secure storage (e.g. for storing authentication keys for securing the boot procedure, as discussed above).

As discussed above, the storage device of the present invention should include a host device interface, such as a USB connector, and a display interface (such as an HDMI connector), and preferably also has wireless connectivity. It could also, if desired, be provided with further interfaces and connections, e.g. for other or additional peripherals, such as a USB host port or ports (a USB female connection), a memory card (e.g. an SD card) slot, etc.

This said, it is envisaged that a particularly preferred embodiment of the present invention is to provide the minimum external interfaces that are required to allow the device to operate (as that will then facilitate providing a compact, small, portable, and cost-effective device). Thus, in one particularly preferred embodiment, the only physical interfaces to external devices provided on the storage device comprise a (single) host device interface (connector) for providing supplemental mass storage to a host electronic device to which the storage device is coupled via that interface, and a (single) display interface (connector). In another preferred embodiment, in addition to these physical interfaces there is a memory card (e.g. an SD or micro-SD card) slot to allow a user to replace the non-volatile mass storage of the storage device.

Accordingly, in a particularly preferred embodiment, the only interfaces to external devices provided on the storage device comprise a (single) host device interface (connector) providing supplemental mass storage to a host electronic device to which the storage device is coupled via that interface and a (single) display interface (connector), or a (single) host device interface providing supplemental mass storage to a host electronic device to which the storage device is coupled via that interface, a (single) display interface and a wireless interface (wireless connectivity), or a (single) host device interface (connector) providing supplemental mass storage to a host electronic device to which the storage device is coupled via that interface, a (single) display interface (connector) and a (single) memory card (e.g. an SD card) slot, or a (single) host device interface providing supplemental mass storage to a host electronic device to which the storage device is coupled via that interface, a (single) display interface, a wireless interface (wireless connectivity) and a (single) memory card (e.g. SD card) slot.

Similarly, while as discussed above the storage device of the present invention can incorporate a number of different features and functions, it is envisaged that the storage device of the present invention will have particular application as a device that provides a minimal, but sufficient, set of features for its intended use and application.

Thus, in a particularly preferred embodiment of the present invention, the portable storage device of the present invention comprises (and only comprises) a non-volatile memory for providing mass storage for a host device to which the storage device can be coupled, a single host device interface, preferably in the form of a USB male connector, a computing environment operable to execute an operating system having a graphical user interface and one or more applications on the storage device, a single display interface, preferably in the form of an HDMI male connector, and wireless connectivity for the computing environment, and does not have an internal power source (other than, e.g., a small battery for, e.g., providing safe shutdown, powering a real-time clock and/or retaining important system states) (but instead can be powered via its host device interface (and must be so-powered when executing the operating system and/or another application in the computing environment)). An internal battery could also be provided to act as a supplemental power source, to provide additional current where the computing environment draws more current than the host device interface is rated for, if desired. The computing environment should include the computing resources required to run a (modern) operating system with a graphical user interface, such as (and preferably), a CPU, a GPU and any control devices needed to operate a (modern) operating system.

It is believed that a storage device having this set of features can provide, in effect, a “minimal” computer in a particularly small and portable configuration (form factor). In particular, the storage device has the minimum number of interfaces for allowing it to function, in effect, as a computing resource in a standalone fashion by being attached to a display via the display interface and controlled with a wireless remote controller such as a wireless keyboard or mouse or smartphone via the computing environment's wireless connectivity, and without any need to couple the storage device to an appropriate host device. The Applicants further believe that this will be advantageous because, for example, it can provide a portable and removable minimal computing system for use, for example, with existing display screens, to provide a “smart” screen. It can also be used to, in effect, provide an upgradable system whereby the storage device can itself be replaced, rather than having to replace the entire screen or display unit, thereby facilitating upgradable “smart” screens.

It can also function as a dual purpose device, providing mass storage to a given host device via the host device interface, but also being able to act as a standalone portable minimal computer with networking connections when, e.g., connected to a display via the display interface.

In these arrangements, the storage device need not have, and preferably does not otherwise have, any built-in (physical) user interface (input/output) components, such as a keypad, display screen, speakers, etc. It may have, for example, a reset and/or on-off button and a power indicator, such as an LED, but preferably does not have any other integrated physical user-interface components.

As discussed above, the fact that the present invention is a mass storage device and provides mass storage functionality is particularly advantageous, as mass storage functionality is typically present in all operating systems, without the need for additional drivers. The storage device of the present invention can accordingly easily be accessed by any host device via its host device interface without the need for the host device to have any special privileges or to have any special drivers installed, etc. The mass storage functionality in combination with the computing environment and display interface also means, e.g., that it is straightforward to move files from a host device (e.g. computer) to the storage device and later display the files on a screen without requiring a connection to (or the presence of) the original host device, nor for the screen itself to have any computing resources. The mass storage functionality also means that applications on a host device do not need any special system privileges to access or control the computing environment on the storage device.

The various components of the storage device are preferably contained within an appropriate housing, from which the male host device and display interface connectors (if any) can and preferably do extend (protrude). As discussed above, there is no need for any (custom-made and/or integrated) input or output functions or units (e.g. built-in keypads, screens or speakers, etc.) to be provided on the housing, as the input and output functions can be and preferably are otherwise provided, as discussed above. Indeed, in a particularly preferred embodiment, the storage device does not include any input or output functions or units on the housing. This facilitates the provision of a “minimal” computer (a compact, small, portable, and cost-effective device), as discussed above. Preferably all user interaction with the storage device in use is achieved via a host device via the host device interface or via a wirelessly connected input (control) device.

While the storage device of the present invention (its housing) can have any physical shape and form factor, it is particularly preferred that the storage device of the present invention will be relatively small and portable. Thus, it preferably has an appropriately small and portable form factor, such as a shape and configuration and form factor similar to existing mass storage devices, such as USB sticks and thumb drives. It could also, for example, correspond to a smart-phone or tablet form factor. In a particularly preferred embodiment, the body of the storage device of the present invention (the external housing of the storage device of the present invention) (excluding any male connectors that may extend beyond the main body) is preferably not more than 5 cm long, 2 cm wide, and 1 cm thick.

The various functions, modules and elements of the present invention can be carried out and implemented in any desired and suitable manner. For example, the functions of the present invention can be implemented in hardware or software, as desired. Thus, for example, the invention may comprise a suitable processor or processors, functional units, circuitry, processing logic, microprocessor arrangements, etc., that are operable to perform the various functions, etc., such as appropriately dedicated hardware elements and/or programmable hardware elements that can be programmed to operate in the desired manner.

Similarly, the computing environment and flash memory (mass storage) element, etc., can be physically arranged as desired on the storage device. For example, although in a preferred embodiment the computing environment is provided as a separate chip or chips to the flash memory element on the storage device, it would be possible to integrate the flash memory and the computing environment in a single chip, if desired. Similarly, the components of the computing environment, such as the application processing part, the interface processing part, the flash memory controller, etc., could all be provided on a single chip, or each as separate chips, or as any other suitable combination of chips, as desired.

As will be appreciated by those skilled in the art, all of the described aspects and embodiments of the present invention can include, as appropriate, any one or more or all of the preferred and optional features described herein.

The methods in accordance with the present invention may be implemented at least partially using software e.g. computer programs. It will thus be seen that when viewed from further aspects the present invention provides computer software specifically adapted to carry out the methods herein described when installed on data processing means, a computer program element comprising computer software code portions for performing the methods herein described when the program element is run on data processing means, and a computer program comprising code means adapted to perform all the steps of a method or of the methods herein described when the program is run on a data processing system. The data processing system may be a microprocessor, a programmable FPGA (Field Programmable Gate Array), etc.

The invention also extends to a computer software carrier comprising such software which when used to operate a microprocessor system comprising data processing means causes in conjunction with said data processing means said system to carry out the steps of the methods of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the methods of the invention need be carried out by computer software and thus from a further broad aspect the present invention provides computer software and such software installed on a computer software carrier for carrying out at least one of the steps of the methods set out herein.

The present invention may accordingly suitably be embodied as a computer program product for use with a computer system. Such an implementation may comprise a series of computer readable instructions fixed on a tangible medium, such as a non-transitory computer readable medium, for example, diskette, CD ROM, ROM, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre loaded with a computer system, for example, on a system ROM or fixed disk, or distributed from a server or electronic bulletin board over a network, for example, the Internet or World Wide Web.

A number of preferred embodiments of the present invention will now be described by way of example only and with reference to the accompanying drawings, in which:

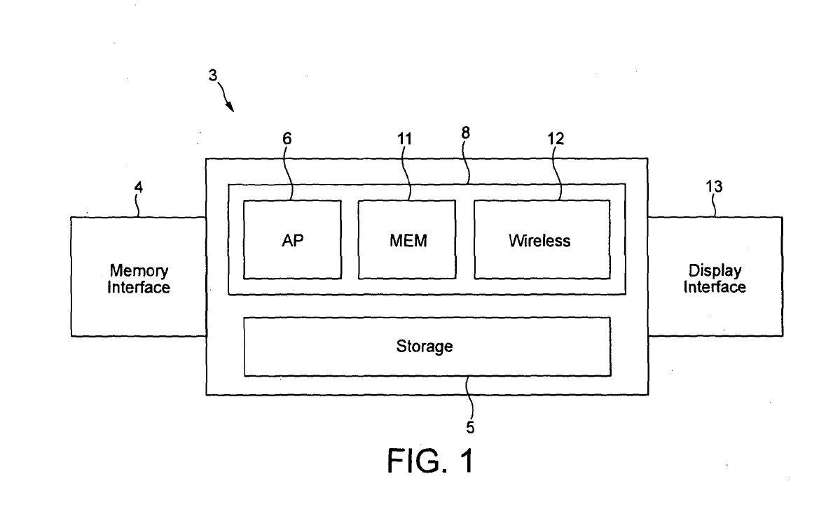

FIG. 1 shows schematically a first embodiment of the storage device of the present invention;

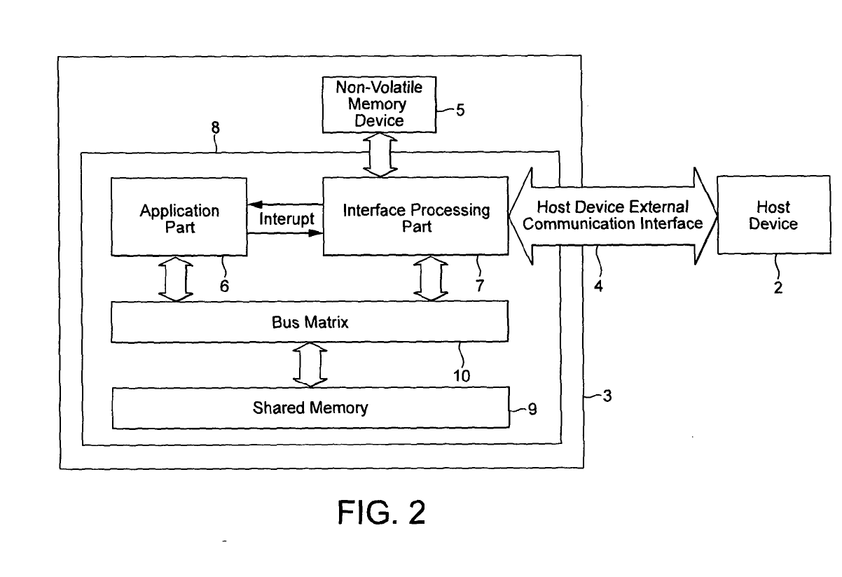

FIG. 2 shows schematically a second embodiment of the storage device of the present invention;

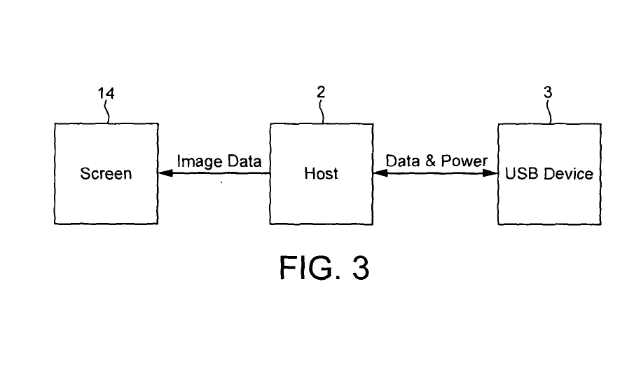

FIG. 3 shows schematically a first arrangement when using the storage device of FIG. 1 or 2;

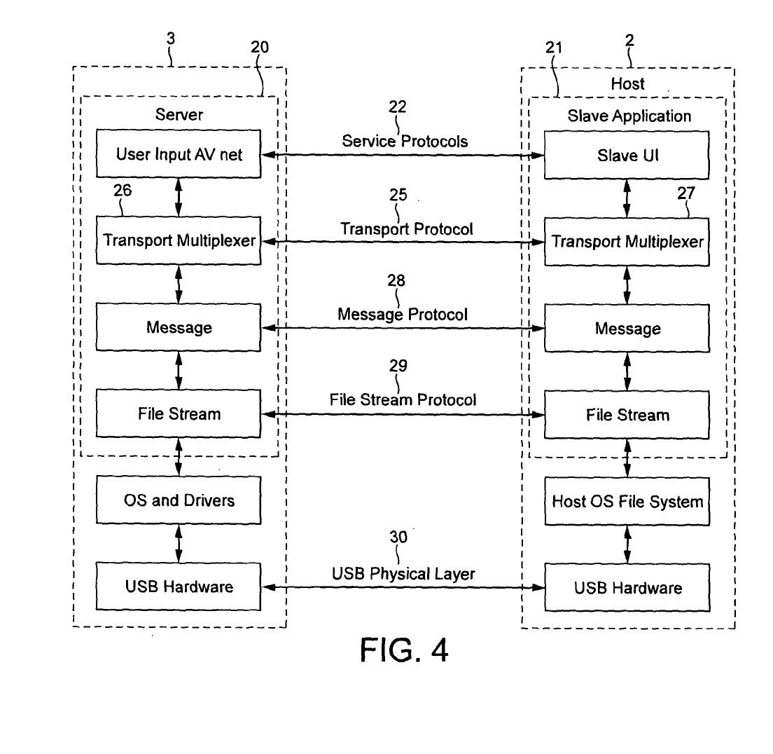

FIG. 4 shows schematically a protocol stack used in the arrangement shown in FIG. 3;

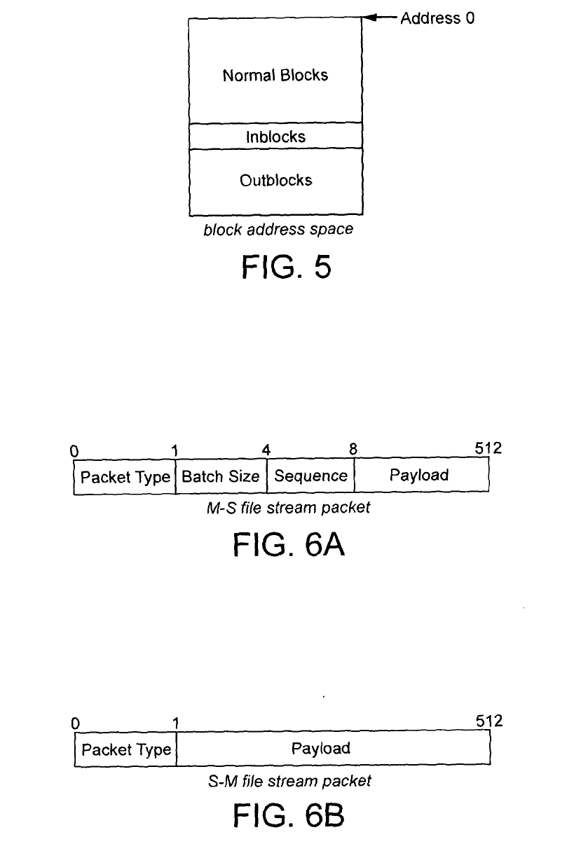

FIG. 5 shows schematically the block address space on the storage device of the arrangement shown in FIG. 3;

FIG. 6 shows schematically the structure of the file stream packets that are transferred between the storage device and the host device in the arrangement shown in FIG. 3;

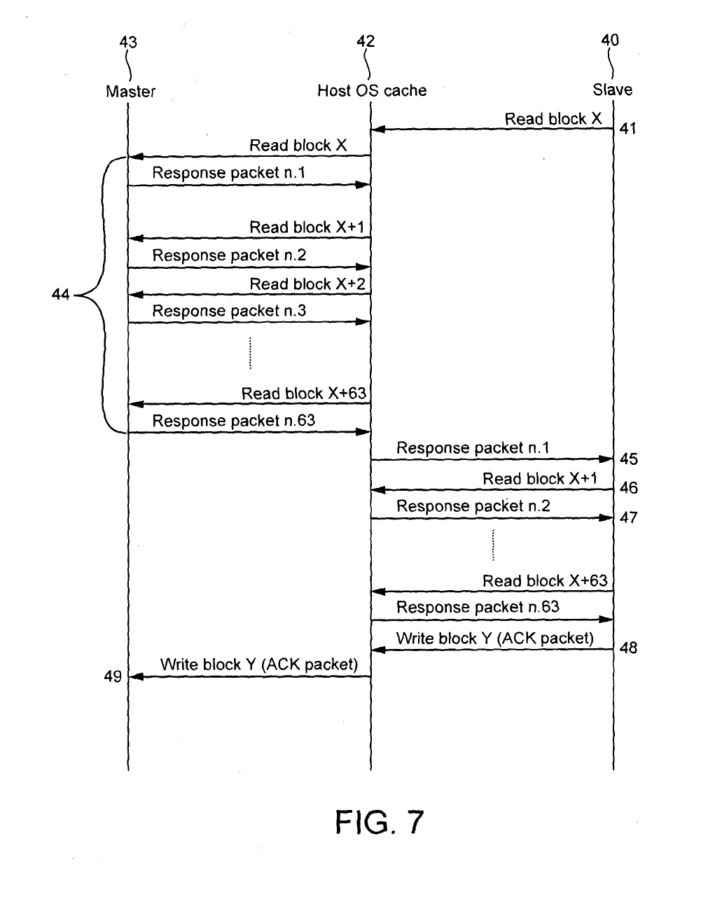

FIG. 7 shows the sequence of actions for a packet read from the host device in the arrangement shown in FIG. 3;

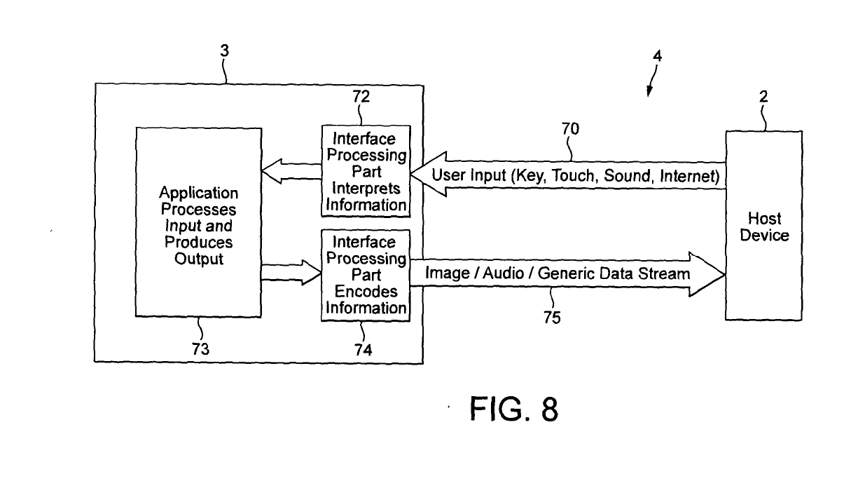

FIG. 8 shows an example of the operation of the arrangement shown in FIG. 3;

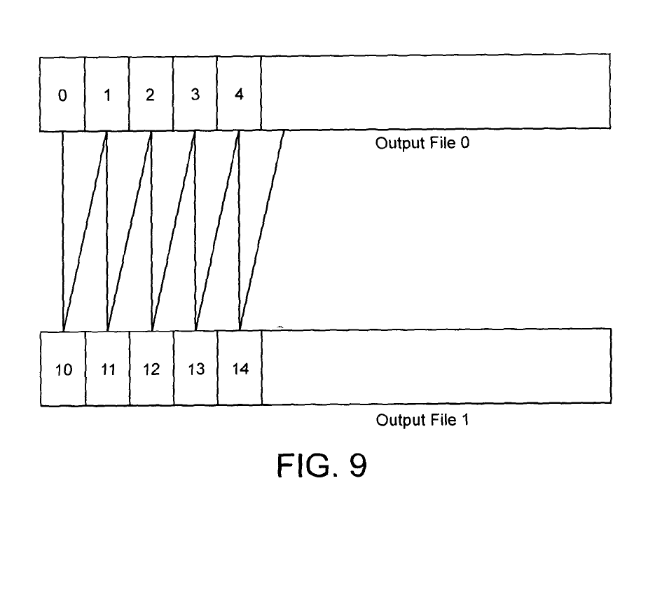

FIG. 9 shows an alternative acknowledgement mechanism; and

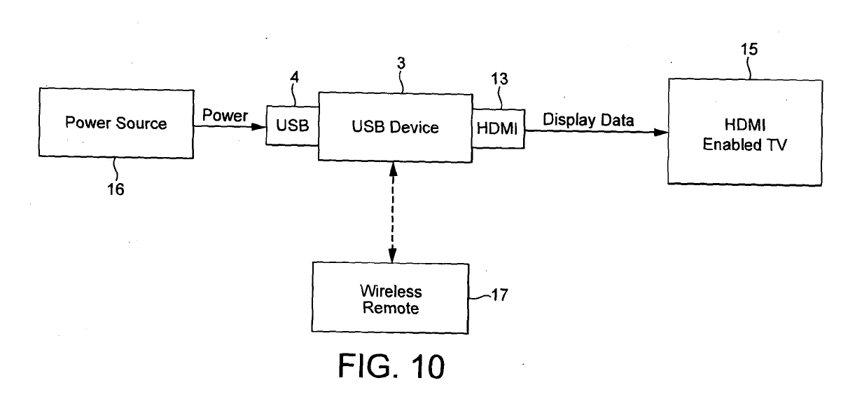

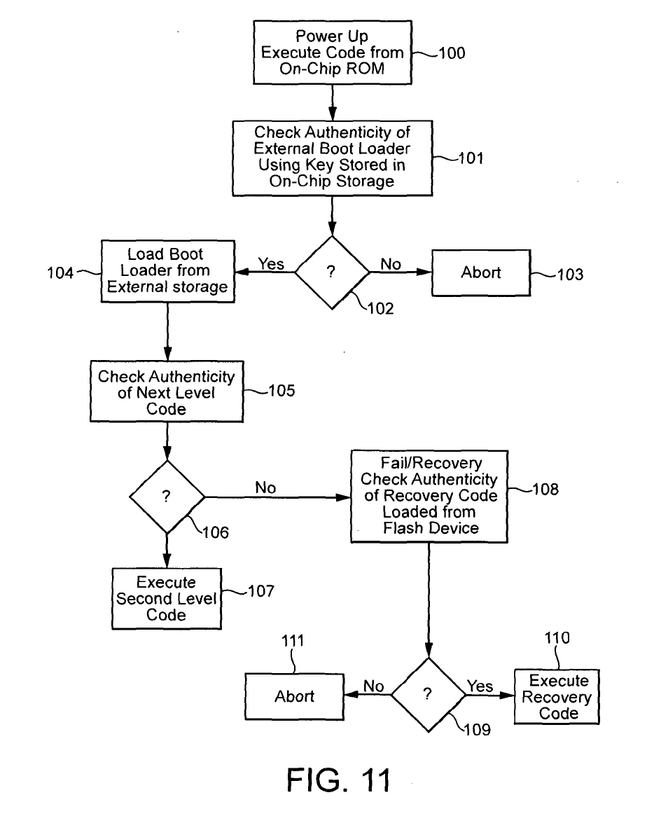

FIG. 10 shows schematically a second arrangement when using the storage device of FIG. 1 or 2;

FIG. 11 shows the boot sequence used for the interface processing part in the embodiment shown in FIG. 2; and

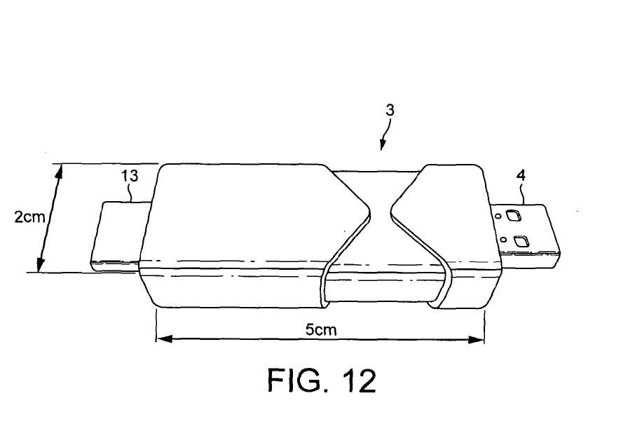

FIG. 12 shows an exemplary form factor for an embodiment of the storage device of the present invention.

Like reference numerals are used for like components throughout the Figures, where appropriate.

FIG. 1 shows schematically an exemplary embodiment of a storage device 1 that is in accordance with the present invention.

As shown in FIG. 1, the storage device 1 includes a flash (non-volatile) memory element 5 for providing mass storage functionality to a host device to which the storage device is coupled. This mass storage memory element 5 is in the form of a removable SD card, so that the storage in the storage device can be replaced and, for example, upgraded, by a user. (It would also be possible for the mass storage element 5 on the storage device 3 to be fixed, e.g. as one or more flash devices, if desired.)

The storage device 3 includes a host device memory interface 4 via which the storage device 3 can be coupled to a host device and provide mass storage functionality to the host device. In the present embodiment the host device interface 4 is in the form of a male USB connector.

(Although in the present embodiment the host device interface 4 is in the form of a male connector, it would be possible for it to be in the form of a female connector (a port), such as a USB port, if desired.)

The host device may, for example, be a mobile phone, a camera, a portable entertainment device, a PDA, a personal navigation device, an in-car navigation or entertainment system, a PC, an appliance such as a TV, printer or washing machine, etc.

The host device interface 4 allows the storage device 3 to act as a mass storage device for an appropriately coupled host device for a host device via the host device interface 4.

The host device interface 4 is also used to provide power to the storage device 3. This may be from a coupled host device, or some other form of external power source that can be connected to the host device interface 4, such as a mains adaptor, an external battery, etc.

In the present embodiment, the storage device 3 accordingly does not include an internal power source (such as a battery), operable to run the computing environment of the storage device, but must be powered through the host device interface 4 in use. Other arrangements, such as including an internal battery for powering the storage device in use could be used, if desired.

The storage device 3 does include a small internal battery (not shown) that is simply operable to, e.g., provide power to facilitate safe shutdown of the storage device, and/or to maintain important internal system states and a real-time clock when the external power source is removed.

It would also be possible to provide an internal battery to act as a supplemental power source so as to ensure that the average current drawn over the host device interface 4 in use does not exceed the allowed maximum rating for such current draw over the host device interface 4. (As is known in the art, a USB connection, for example, has a maximum allowed current rating.) In this case, if, for example, the instantaneous current drawn by the computing environment 8 exceeds the maximum rated current for the host device interface 4, then this internal battery will be used to provide additional current so as to ensure that the average current drawn over the host device interface 4 does not exceed the maximum allowed current rating. When the current being drawn by the storage device 3 does not exceed the current rating for the host device interface 4, then the system may revert to providing all the current for the storage device 3 via the host device interface 4. In this arrangement, the internal battery of the storage device 3 will effectively act to limit the current drawn in operation via the host device interface 4, so that the current draw does not exceed the allowed maximum rating for the host device interface 4.

The storage device 3 is configured such that any internal battery of the storage device 3 can be appropriately recharged when power is being provided via the host device interface 4.

The storage device 3 is configured such that it will communicate with a host device via the host device interface 4 using a standard mass storage communications protocol. Thus the communications protocol between the storage device 3 and a host device 2 via the host device interface 4 comprises a mass storage communications interface (an interface that supports mass storage access from a host device).

In the present embodiment, the USB-OTG (USB On-the-Go) protocol is used (with the storage device 3 being the slave device), but other arrangements, such as a “standard” USB interface or an SD interface for communicating with the host device could be used, as desired, e.g. depending upon the nature of the storage device 3.

Thus the communications interface between the storage device 3 and a host device 2 via the storage device's host device interface 4 is such that when the storage device 3 and a host device 2 are coupled to each other via the host device interface 4 of the storage device, the host device always and automatically acts as the master device (as the protocol master), and the storage device acts as the slave device, i.e. only the host device can schedule the configuration and data transfers over the host device interface: the storage device cannot initiate data transfers but can only respond to requests from the host device.

The storage device 3 accordingly presents as a slave mass storage device to any host device that is coupled to the storage device 3 via the storage device's host device interface 4. In other words, the storage device 3 is a slave device (a USB slave device in this embodiment) having a mass storage function.

As well as the mass storage element 5, the storage device also includes a computing environment 8, which in this embodiment comprises an application processing part 6, a system memory 11, and wireless interface support (a wireless connection) 12.

The application processing part 6 includes an application processor comprising a processing device containing a system-on-chip comprised of a CPU and/or GPU and any required peripherals for the computing system provided by the application processing part 6, such as a real-time clock, debug port, debugging infrastructure, peripherals, power management, and clock control, etc.

The processor of the application processing part 6 is operable to execute a modern operating system providing a graphical user interface, and to execute one or more applications on the storage device 3 (in the computing environment 8 of the storage device 3).

The applications may be stored, for example, in the flash memory element 5 of the storage device 3 and then loaded appropriately into the system memory 11 when they are to be executed. Applications can also be executed directly from the flash memory 5.

In addition to the operating system, the applications that may be executed in the application processing part 6 of the computing environment 8 of the storage device 3 may comprise any suitable and desired applications, such as games, productivity applications such as presentation applications, spreadsheets or word processors, Internet browsers, e-mail clients, video and audio editing tools, Internet applications, user interface applications such as stock viewers, weather programs, flight schedules, etc. The application processing part 6 could execute plural applications simultaneously and/or support plural applications, if desired.

The system memory 11 is a suitable volatile, random access memory, that can be used appropriately by the operating system and applications executing on the application processor.

The wireless connectivity support 12 comprises appropriate wireless interface for network connectivity and for remote control, such as a Wi-Fi, Bluetooth or other radio wireless interface. The wireless interface 12 can be used, e.g., to connect the computing environment 8 to the Internet, to Cloud resources, and/or to wireless input or control devices, such as a wireless mouse or keyboard, or a smartphone.

In the present embodiment, the computing environment 8 is provided on a separate chip, with the mass storage, flash memory element 5, for example, also being provided as a separate chip, with the various chips then being appropriately connected together and mounted on an appropriate substrate. Other arrangements, such as providing the computing environment 8, and flash memory element 5, etc., all on the same chip would equally be possible, if desired.

As well as the host device memory interface 4, the storage device 3 also includes a display interface 13 that is able to couple the storage device 3 to a display, such as a display screen, and via which graphical outputs generated by the operating system and applications executing in the computing environment 8 on the storage device 3 can be displayed on the display. In the present embodiment the display interface 13 comprises a male HDMI connector, but other interfaces, such as DVI, VGA, etc., can be used if desired. The display interface 13 also supports and provides an audio output from the operating system and applications executing in the computing environment 8 of the storage device 3.

(Although in the present embodiment the display interface 13 is in the form of a male connector, it would be possible for it to be in the form of a female connector (a port), if desired.)

In the present embodiment, the application processing part 6 of the computing environment 8 on the storage device 3 performs, inter alia, the following functions: transfer of data between the host device 2 and the application processing part 6 of the storage device; mass storage memory mode handling for the host device; initialization of the application processor in the application processing part 6; and initialization and handshaking with the host device 2.

The application processing part 6 also provides the nonvolatile, mass storage device functions to the host device 2. Thus, the application processing part 6 controls access to and from the non-volatile mass storage 5 of the storage device 3, i.e. the application processing part 6 provides the “normal” mass storage functionality of the storage device 3 to a host device 2 via the host device interface 4.

To do this, the application processing part 6 executes a suitable mass storage device driver as part of its operating system. Other arrangements, such as providing a suitable mass storage (non-volatile memory) controller, such as a NAND or NOR flash device controller, or other controller that performs lower level access to a non-volatile storage device, as part of the computing environment 8 would be possible, if desired.

The application processing part 6 of the computing environment 8 also executes an application operable to interface (translate), if required, between the mass storage communications protocol used between the host device 2 and the storage device 3, and a communications protocol required or expected by an application being executed on the application processor in the application processing part 6 of the storage device 3.

The interface (translation) function of the application processor (if provided) is operable to take data received from the host device and convert it to the appropriate data structures that the application processor(s) uses, and vice-versa. Thus, the interface function accordingly translates between the application processor and the data protocol used between the storage device 3 and the host device 2.

Although FIG. 1 shows the storage device 3 as being a USB device and as using the USB protocol for its host device interface 4, other mass storage form factors and interfaces could be used, if desired. For example, the storage device could be in the form of an SD card (have an SD card form factor), and use an SD interface (bus) and protocol for its host device interface 4.

FIG. 2 shows schematically an alternative embodiment of the computing environment 8 on the storage device 3.

In this case, the computing environment 8 comprises an application processing part 6, a separate interface processing part 7, and a shared memory 9 for use by the application processing part 6 and the interface processing part 7 via a bus matrix 10 to communicate with each other.

In this embodiment, the computing environment 8 is again provided on a separate chip, with the flash memory element 5, for example, also being provided as a separate chip, with the various chips then being appropriately connected together and mounted on an appropriate substrate. Other arrangements, such as providing the computing environment 8, and flash memory element 5, etc., all on the same chip, or providing the components of the computing environment 8, such as the application processing part and the interface processing part, each as separate chips, would equally be possible, if desired.

In this embodiment, the application processor or processors of the application processing part 6 as well as executing an operating system and one or more applications, also executes a driver for communication with the interface processing part 7, to allow the application processor to communicate with the interface processor. The interface processing part 7 is self-standing and all communication with the application processing part 6 is done via shared memory.

The interface processing part 7 of the computing environment 8 is a processing component that facilitates in particular transparent data communication between a host device 2 and the application processing part (system) 6. In the present embodiment, as will be discussed further below, the interface processing part 7 is also configured so as to allow the host device 2 to access the normal mass storage functions 5 of the storage device 3 with minimal power consumption.

Thus, as well as its communication with the application processing part 6 of the computing environment 8 (which will be discussed in more detail below), the interface processing part 7 of the computing environment 8 is also able to communicate with a host device 2 via the host device interface 4 and the normal flash memory mass storage element 5 of the storage device 3. It accordingly has communications interfaces to the host device 2, and to the non-volatile memory element 5, and to the application processing part 6 of the computing environment 8 of the storage device 3.

In the present embodiment, the interface processing part 7 of the computing environment 8 on the storage device 3 performs the following functions: transfer of data between the host device 2 and the application processing part 6 of the storage device; memory card mode handling for the host device; initialization of the application processor in the application processing part 6; initialization and handshaking with the host device 2; and providing the nonvolatile storage device functions to the host device 2.

To achieve this, in the present embodiment, the interface processing part 7 of the computing environment 8 on the storage device 3 includes: a CPU or other controller able to control the components of the interface processing part 7, carry out initialisation and handshaking functions, etc.; an external interface controller to the host device (in the present embodiment, a USB interface supporting mass storage access from a host device controller is used); a non-volatile memory controller (this can, e.g., be a NAND flash device controller, NOR flash controller or other controller that performs lower level access to a non-volatile storage device); some internal system memory (for use as working space memory); a debugging infrastructure (such as jtag, uart etc.); a component for compression and encoding of video, audio or data; a boot ROM for booting of the system and storing application code; an interrupt controller with connection to all the application processor interrupt sources and internal interrupt sources; and some secure storage for storing authentication keys to be used to secure the boot procedure (not shown).

Other arrangements, and functionality, etc., for the interface processing part 7 of the computing environment 8 of the storage device 3 would, of course, be possible.

The interface processing part 7 of the computing environment 8 also includes a processor (which may be a CPU, dedicated hardware, etc., as desired) operable to interface (translate) between the communications protocol used between the host device 2 and the storage device 3, and a communications protocol required or expected by an application being executed on the application processor in the application processing part 6 of the storage device 3. This interface processor may be the same as or different to the processor (e.g. CPU) that controls the components of the interface processing part 7.

The interface (translation) function of the interface processor is operable to take data received from the host device and convert it to the appropriate data structures that the application processor(s) uses, and vice-versa. Thus, the interface processor accordingly translates between the application processor and the data protocol used between the storage device 3 and the host device 2 (rather than the application processor doing this).

In the present embodiment, the interface processor, as well as being able to convert data between the protocol required for communication with the host device, and the protocol required by application processing part, is also able to encode and/or compress data to be sent to the host device. This reduces the data transfer requirements for sending data to the host device 2, and accordingly reduces power usage, for example.

In the present embodiment, the communications interface between the interface processing part 7 and the host device 2 comprises, as discussed above, a mass storage communications interface (an interface that supports mass storage access from a host device) in the form of a USB interface.

In the present embodiment, communication between the interface processing part 7 and the application processing part 6 of the computing environment 8 of the storage device 3 takes place, as shown, via shared memory 9. This is advantageous from a hardware perspective and may also, e.g., facilitate enhanced security.

Thus, the interface processing part 7 of the storage device 3 includes appropriate elements and functionality for communicating with the application processing part via the shared memory 9, and the application processing part 6 correspondingly includes appropriate elements and functionality for communicating with the interface processing part via the shared memory 9. Thus, the interface processing part 7 accesses data structures stored by the application processing part 6 in the shared memory 9 to receive communications from the application processing part 6 and vice-versa.

Thus, in the present embodiment, the interface processing part 7 is operable to fetch data structures that have been written to the shared memory 9 by the application processing part 6, and to process those data structures into a form suitable for transfer to the host device 2, and is operable to process data structures received from the host device 2 into a form suitable for transfer to the application processor 6 and to write those data structures to the shared memory 9 for use by the application processing part 6.

An interrupt mechanism is also provided between the application processing part 6 and the interface processing part 7 of the computing environment 8 on the storage device 3, to facilitate communication between the application processor and the interface processor and vice-versa. This interrupt mechanism may then be used, e.g., to cause the application processor to respond to inputs from the host device 2 (the client side) that have been processed by the interface processor (and, e.g., placed in the shared memory 9).

The interface processing part 7 accordingly includes an interrupt controller, which interrupt controller is coupled to all the interrupt sources of the application processing part 6, and all the internal interrupt sources of the interface processing part 7.

In the present embodiment, interrupts from the application processing part 6 to the interface processing part 7 are carried out by having all the application processor interrupts available on the interrupt controller of the interface processing part 7.

Other arrangements would be possible. For example, the application processor interrupts could also or instead be handled by the application processor interrupt controller, with interrupts needed for the interface processing part 7 being raised by writing to an interface processing part register. It would also or instead be possible, e.g., to have an extra interrupt controller in the application processing part 6 that groups all interrupts to the interface processing part 7, and makes all application processing part interrupts available to the interface processing part.

The interface processing part 7 has the ability to interrupt the application processing part 6 via an interrupt signal exiting from the interface processing part.

In this way, the interface processor in the interface processing part 7 communicates with the application processor in the application processing part 6 of the computing environment 8 via interrupts and the shared memory 9.

Where the interface processing part includes separate controller component (such as an SD controller, a flash controller, etc.) inside the interface processing part, then the application processing part can preferably access these components.

The components of the interface processing part, such as the NAND flash controller, physical interface controller, etc. are accessed by the application processing part over a shared bus. Access from the application processing part to these components is controlled by the interface processing part.

As discussed above, in this embodiment, the interface processing part 7 controls access to and from the non-volatile mass storage 5 of the storage device 3. Thus, the interface processing part 7 provides the “normal” mass storage functionality of the storage device 3 to the host device 2. To do this, the interface processing part 7 executes a suitable mass storage device driver.

In the present embodiment, the interface processing part 7 controls access by the application processing part 6 to areas of the mass storage (flash memory) 5 on the storage device 3, and controls access by the host device 2 to areas of the mass storage (flash memory) 5 on the storage device 3.

This has the effect that all access to the mass storage 5 on the storage device 3 requires permission of the interface processing part 7, such that the interface processing part accordingly acts as a firewall between the host device 2 and the mass storage 5 on the storage device 3, and between the application processing part 6 and the mass storage 5 on the storage device 3. This can enhance the security of the system, for example by preventing malicious code from being transferred from a host device to the application processing part and vice-versa.

The computing environment 8 is configured so as to only enable (boot) the interface processor (the interface processing part 7) on the storage device 3 at power up. This helps to ensure lower power usage. It also has the advantage that where the application processor(s) is not needed, e.g., because the host device 2 simply requires mass storage operation, then the application processor does not need to be enabled, thereby saving power, etc. (as the interface processor alone supports that).

Also, only a minimum of components run at power up and the interface processor runs at a lower clock frequency until it receives a request for more performance (at which point it can then increase the clock frequency, control the power controller, etc., to provide increased performance).

The interface processor (the interface processing part 7) may be booted as desired. In the present embodiment, the interface processing part 7 has a boot ROM and boots from that boot ROM. Once it has started to boot, the interface processor then continues to boot using data and code stored in the mass storage memory 5 of the storage device 3. It can also use data and code stored on the host device 3 and/or from over the Internet for this, if required (e.g. where the relevant data is not yet stored in the memory 5 on the storage device).

FIG. 11 shows a preferred procedure that is used for booting the interface processing part 7 in the present embodiment in more detail.

As shown in FIG. 11, when the interface processing part is first powered-up, it will proceed to execute boot code that is stored in the boot ROM that is present in the interface processing part 7 to start the boot procedure (step 100).

Once this boot code has been executed, the interface processing part 7 then checks the authenticity of the boot loader data and code that is stored in the external mass storage memory 5 of the storage device 3 (step 101). In the present embodiment this is done by reading a public authentication key that is stored with the boot loader code in the mass storage memory 5 of the storage device 3, and then comparing that authentication key (or, e.g., a hash of that key) with a copy of the key (or of a hash of the key, respectively) that is already contained in a secure storage section of the boot ROM of the interface processing part 7.

If this authenticity check (step 102) indicates that the keys (or the hashes of the key) do not match, then the boot procedure is aborted (step 103). This is because if the authentication check is not successful, that would suggest that the boot code in the mass storage memory 5 of the storage device 3 has been modified or otherwise interfered with, and therefore that security has potentially been breached.

On the other hand, if the authenticity (security) check (step 102) is successful, then the interface processing part 7 can proceed to load and execute the boot loader data and code from the mass storage memory 5 of the storage device 3 to continue with the boot procedure (step 104).

When the next level of boot loader code (such as, e.g., kernel, OS, or special application code) is to be executed, a further authenticity (security) check for that next level of boot code is performed (step 105). This authentication check again preferably comprises comparing a key or a hash of a key that is stored in association with the next level of boot code in the mass storage memory 5 of the storage device 3 with a corresponding version of that key (or hash of that key) that is stored in the secure storage of the interface processing part 7.

If this security check (step 106) is successful, then the boot procedure will proceed to execute the second level boot code stored in the mass storage memory 5 of the storage device 3 (step 107), after which the boot procedure is completed and the interface processing part 7 will be enabled.

At this stage, for example, a kernel stored in the mass storage memory 5 of the storage device 3 will mount file systems according to the desired set-up, and continue with user space initialisation. This will then start the necessary applications and GUI for the device to become enabled.

If the second level of boot code authenticity check fails at step 105, then the interface processing part enters a recovery boot procedure (step 108).

In the recovery boot procedure, the system can attempt a recovery boot. In this arrangement, the interface processing part 7 attempts to boot from a rescue image (comprising boot loader code and data) that is provided on a further external storage device, such as an SD card, that may be provided by the user and coupled to the storage device 3. Again, if an attempt to boot using this rescue image is to be made, the interface processing part 7 first carries out an authentication check to determine whether an authentication key (or a hash of that key) that is stored in the boot rescue image on the external storage device matches the key (or hash) value stored in the boot ROM of the interface processing part 7. (The authentication key that is stored in the boot rescue image may be a signature that is generated from a secure private key, for example.)

If this authentication procedure (step 109) is successful (thereby indicating that the rescue image on the external storage device has not been tampered with), then the interface processing part proceeds to execute the recovery code (step 110) on the external storage device and proceeds with the normal boot procedure using the rescue image in the manner described above.

The rescue image (boot code and data) could, e.g., be executed directly from the external storage device, or it could, e.g., be loaded from the external storage device on to the storage device 3, by copying the rescue image from the external storage device to the mass storage memory 5 of the storage device 3, and then, once the rescue image has been copied to the mass storage memory 5 of the storage device 3, the system could proceed with the normal boot procedure using the rescue image copied to the mass storage memory 5 of the storage device 3 in the manner described above.

If the check of the rescue image on the external storage device fails, then the procedure is aborted (step 111).

This latter recovery procedure (i.e. executing a rescue image from an external storage device and then proceeding to boot from that rescue image), can also be used, if desired, for initial booting of the system for the first time, in the situation where, for example, there is no boot data and code yet stored in the mass storage memory 5 of the storage device 3, or for system recovery or system maintenance. In these arrangements, the “rescue image” could, e.g., be copied to the mass storage memory 5 of the storage device 3, so that the system can subsequently be booted from boot code and data that is stored in the mass storage memory 5 of the storage device 3.

The application processor (the application processing part 6) is enabled (booted) at a later time, after the interface processor (the interface processing part 7) has been booted, and only in response to some event that indicates a need for the application processor (for the application processing part 6). In the present embodiment, the triggering event is an appropriate user input, such as the activation of a client application on a connected host device or a user input via a wireless remote control. In response to this, the system will then start to boot the application processor (the application processing part 6) on the storage device 3. The application processor is preferably booted by means of the interface processor giving the relevant mass storage boot address to the application processor.

Thus, in the present embodiment, the computing environment 8 on the storage device is enabled (booted) in two stages, firstly (at power up) to a mass storage operation mode by booting the interface processor only, and, if required, then, in a second, subsequent stage, to a full application processing mode by booting the application processor(s). (Other arrangements would, of course be possible.)

In the present embodiment, the storage device 3 is also configured such that the application processor (the application processing part 6) will only be enabled (booted) if the coupled host device 2 or other external power source can provide the necessary power, performance, etc. to power the application processor (the application processing part 6).

In the present embodiments, the storage device 3, as well as being able to provide its normal “mass storage” function to a host device via the host device interface 4, can also interact with a host device via the host device interface 4 to allow a host device to which the storage device 3 is coupled via the host device interface 4 to act as an input and an output device for the computing environment 8 of the storage device 3.

FIG. 3 illustrates this, and shows the storage device 3 coupled to a host device 2 via its host device interface 4.

The host device 2 in this arrangement is any computing device that has appropriate USB port (for receiving the host device interface connector 4 of the storage device 3) and that has the ability to interact with a mass storage device using a mass storage communications protocol, and that has an appropriate screen 14 (which can be any computer screen, either cabled or remote, etc.), that is capable of displaying the graphical user interface from the host computer 2. The host computer 2 is in this example a computer (a PC) which is running a modern graphical operating system. Other arrangements would, of course, be possible.

In this arrangement, in order for the host computer 2 to be used as an input/output device for the computing environment on the storage device 3, the storage device 3 should first be connected to the host computer 2 via the host device interface and connector 4. Once this is done, the storage device 3 can receive data and power from the host computer 2 via the host device connector and interface 4.

Once the storage device 3 is appropriately coupled to the host computer 2, then as will be discussed in more detail below, an appropriate client application is started on the host computer 2 to allow the host computer 2 to access the file system exposed from the storage device 3 via the storage device mass storage communications protocol via the host device interface 4. Using this protocol, the host computer 2 is then able to send user input and data to the storage device 3, and read data from the storage device for the host device 2 to then display on the screen 14 connected to the host computer 2.

It should be noted that in these arrangements the host computer 2 acts only to relay user inputs and data to the storage device 3, and to output output data provided by the storage device 3. The storage device 3 therefore acts in this arrangement as a “master” controlling “slave” user input and output functions of the host device 2. (However, the data transfer between the host device 2 and the storage device 3 via the host device interface 4 still has the host device as the “master”, as discussed above (as the host device controls all communication and data transfer across the host device interface 4: it is just that it is the storage device that is in effect, controlling the input (and output) functions of the host device, and so acting as the “master” of those host device functions.)

In order to allow a host device to act as an input and output device for, and to control the operating system and applications executing in, the computing environment 8 of the storage device 3, via the host device interface 4, the computing environment 8 of the storage device 3 is, in this embodiment, operable to execute a set of software components that together provide a server module (a server function) on the storage device 3. There is then a corresponding set of client software components on the host device 2 that together provide a client module (a client function) on the host device 2 that can cooperate with the server module (function) on the storage device 3 to allow an application that is being executed in the computing environment 8 of the storage device 3 to access and use, inter alia, input and output functions of the host device 2.

In effect, the server components running in the computing environment 8 constitute a server module that allows the storage device 3 to act as a master controlling functions of the host device 2, via a corresponding client module formed by the client components of the host device 2, via the storage device's host device interface 4. The arrangement is such that the host device 2 can act as a thin client providing user input and output functions for an application that is running in the computing environment 8 on the storage device 3.

In the present embodiment, the server module may be executed in the application processor in the application processing part 6 or, e.g., in the interface processor on the interface processing part 7 of the computing environment 8 (if provided) or in a distributed fashion across both the interface processing part 7 (if provided) and the application processing part 6 on the storage device 3, if desired. Having the interface processing part (if provided) provide the server function on the storage device 3 would avoid stealing any performance from the application processor and the application processing part 6 for performing the server function.

The operation of the server module and the client module to facilitate using a host device 2 as an input and output device for the computing environment 8 on the storage device 3 via the storage device's host device interface 4 in the present embodiment will now be described in more detail.

FIG. 4 shows schematically the relevant server 20 and client 21 software stack and protocols that are provided on the storage device 3 and the host device 2, respectively. The software running in the computing environment 8 of the storage device 3 acts as the “master” and the client software running on the host device is the corresponding “slave”. Communications between the respective layers of the protocol stack over a defined protocol are shown with dashed lines in FIG. 4, while actual physical communication paths are shown with solid lines.

As shown in FIG. 4, the top protocol layer is the service layer 22.

Each application that may be executed on the storage device 3 has access to an API which provides all operating system and input/output functionality for the application. The API is implemented either as shared or static libraries and therefore runs in the same context as the application.

The API libraries provide the service protocol layer 22 which is a set of protocols for different services which the client module on the host device will provide for the application that is running on the storage device, such as access to the display, and keyboard on the host device (in effect, a slave user interface, etc., on the host device). In the present embodiment, each service is one specific functionality, such as graphics output or key press events.

Each service has a defined service protocol, and represents a certain capability, such as a key input service. In operation, when a service is in use, a “channel” linked to the service is opened through which, for example, events relating to the service can be sent and received. For example, if a slave host device registers a key input service, the master server component on the storage device can open a channel linked to that key input service and then receive key input events through that channel. Several channels can be opened to the same service (and all channels must be linked to a service).

The next layer down in the protocol stack is the transport protocol layer 25. There is a corresponding transport multiplexer component 26, 27 in the server module 20 on the storage device 3 and in the client module 21 on the host device 2.

The transport protocol layer 25 acts to combine the plural individual service channels of the service protocol layer 22 into a single channel for communications that are passing down the protocol stack from the service protocol layer, and, correspondingly, acts to de-multiplex the single “channel” that it will receive from the lower message protocol layer 28 (which will be discussed further below) into the appropriate number of individual channels needed for the service layer 22. The latter is accomplished by tagging messages received from the message protocol layer 28 with the appropriate channel numbers.

The protocol layer below the transport protocol layer 25 is the message protocol layer 28. The purpose of this protocol is to provide the higher layers of the protocol stack with the possibility of sending and receiving messages of arbitrary length (whereas, as will be discussed further below, the lower layers of the protocol stack are constrained to send messages of fixed, or at least predetermined, length).

The message protocol uses message protocol packets which have the following structure:

bytes 0-3: number of bytes in the payload

bytes 4-7: number of FAT stream packets this message is composed from

bytes 8-: payload.

To do this, the message protocol operates to segment messages that it receives from the higher layers (from the transport protocol layer 25) into the FAT stream packets that the lower file stream protocol layer 29 uses (as will be discussed further below), and, similarly, for communications received from the file stream protocol layer 29 for provision to the higher layers, acts to concatenate the FAT stream packets that it receives from the file stream protocol layer 29 into longer messages.

The next layer down the protocol stack is the file stream protocol layer 29. The purpose of this layer is to make sure that the packet transport over the USB physical layer 30 (which is the actual physical communication medium that is used between the server module on the storage device 3 and the client module on the host device 2 via the host device interface 4, as discussed above) is reliable and efficient. The communication arrangement over the USB physical layer 30 will therefore first be described, before returning to a more detailed description of the file stream protocol 29.

As shown in FIG. 4, the physical communication between the storage device 3 and the host electronic device 2 takes place via the USB (Universal Serial Bus) interface (the USB physical layer) (as the storage device 3 is in this embodiment a USB device). This physical layer is used for all communications between the storage device 3 and the host device 2, including the communication between the storage device 3 and the host device 2 when the storage device 3 is acting as a master to the host device 2. This has the advantage that the host device 2 and storage device 3 continue to operate in their normal fashion with respect to the physical layer, notwithstanding that the host device 2 may in fact be acting as a slave for an application that is running on the storage device 3.

(Other arrangements for the physical layer 30, such as using any other appropriate mass storage protocol, such as the SD (Secure Digital) standard (the SD physical layer), would be possible, if desired.)

The USB physical layer 30 follows the USB standard. In the present embodiment, communication between the storage device 3, and the host device 2, including all communications relating to the client and server operation, takes place via data transfers of blocks of 512 bytes, with each block having an address, starting at 0 and increasing, in accordance with the USB protocol. (Block sizes of other than 512 bytes could be used, if desired.)

As in normal USB standard operation the memory card storage device 3 would handle every block address as either a read or write to the corresponding block in the flash memory element 5, in the present embodiment the block addresses that the host device 2 may read from or write to are classified into three different types, such that depending upon which address the host device is reading from or writing to, the storage device (namely the server module on the storage device) can interpret that data transfer accordingly.

The first type of block address is any block address that is in the address space of the flash storage area 5 of the storage device 3. If the host device reads from or writes to such a block address, then the server module on the storage device 3 allows the normal USB mass storage operation to be carried out (namely a read of or write to the appropriate flash storage area). Blocks having these addresses can accordingly be thought of as “normal” blocks.

However, in order to facilitate the server/client operation of the present embodiment, two further types of block address defined and that, in particular, the server module on the storage device 3 can recognise.

The first such block address is an “input” block address. If the server module on the storage device 3 sees the host device 2 writing to such an “input” block address, that is interpreted by the server module on the storage device 3 as being a data transfer from the client module on the host device for processing by the server module on the storage device 3. The server module 3 is accordingly configured to recognise when the host device writes blocks to an “input” block address and in response thereto to pass the blocks for processing by the higher levels of the server module protocol stack. This then allows the client module on the host device 2 to send communications for the server module (for an application being executed on the storage device 3) on the storage device 3 by writing blocks to the defined input block addresses.

There is correspondingly a defined set of “output” block addresses. These addresses are used for communication from the server module on the storage device 3 to the client module on the host device 2. When the server module on the storage device 3 sees the host device 2 reading from one of the defined “output” block addresses, the server module on the storage device 3 again intercepts that “read” and transfers the next waiting messages from the higher levels of the server module protocol stack to the host device 2 (to the client module on the host device 2). (The client module “knows” that it has read an output address and so treats any data transferred in response to that read as data that it should process.)

FIG. 5 shows schematically the above block address space arrangement on the storage device 3.

The “normal blocks” have addresses within the normal address space of the flash memory element 5 on the storage device 3, and, as discussed above, any read or write to such a normal block address results in the same behaviour as would normally be the case for the storage device 3, namely appropriate reads or writes to the flash storage area 5.

The input block and output block addresses shown in FIG. 5 are, on the other hand, not within the normal address space of the flash memory element 5, but are instead, in effect, “virtual” addresses that are used to trigger the transfer of data between the server and client modules on the storage device 3 and the host device 2. Thus, as discussed above, writes to input block addresses and reads of output block addresses by the host device 2 do not result in writes to or reads of, respectively, corresponding block addresses in the flash storage element 5, but are instead “intercepted” by the server module on the storage device 3 and interpreted appropriately either as communications from the client module to the server module or requests from the client module to receive communications from the server module (with the server module then responding appropriately).

To facilitate the above “input” and “output” block address operation, two special files are created by the server module on the storage device 3 through manipulation of the file access tables and directory tables in the flash storage area 5 of the storage device.

One of these files, called in the present embodiment /fxiout.str, has all the output blocks allocated to it, such that any read from this file will result in a read from an output block (and so is used for communication from the server module on the storage device to the client module on the host electronic device).

The other file, called in the present embodiment /fxiin.str, has all the input blocks allocated to it, such that any write to this file will result in a write to an input block (and so is used for communications from the client module on the host device to the server module on the storage device).

In this way, the client module on the host electronic device can read /fxiout.str or write to /fxiin.str in order to communicate with the server module on the storage device 3.

The above describes the data transfer protocol for the physical layer 30. However, the Applicants have recognised that it may be necessary to take steps to ensure that the data transport over the physical layer 30 in the manner discussed above is reliable and efficient. As discussed above, this is the function of the file stream protocol layer 29.

The file stream protocol 29 transfers data between the client and server modules in the form of file stream packets. Each file stream packet fits into one 512 byte block and includes a packet header and a payload. The payload is the useful data that is being transferred between the server module and the client module and can comprise, for example, commands, content or other data. (As will be appreciated by those skilled in the art, each file stream packet should be configured to be of an appropriate size for the storage device (physical) communication protocol in question. Thus, although as set out above in the present embodiment the file stream packets are configured to fit within the appropriately sized USB blocks, for other forms of storage device, other sizes of file stream packet could and preferably should, be used.)

In the case of file stream packets being sent from the server module on the storage device 3 to the client module on the host device 2 (i.e. in essence for “output”, master-to-slave (M-S) file stream packets), the packet header has three fields, a packet-type field, a packet sequence number and a packet batch size. This is shown in FIG. 6A.

The packet-type field indicates either NO DATA (0) or DATA (1). DATA packets are packets having payloads that are to be processed by the receiver. NO DATA packets are used to “pad” data transfers when there are no DATA packets ready to be sent to the client module.

The packet sequence number is unique and increasing. As will be discussed further below, this is used by the client module to determine if its packet read was incorrect or not.

The packet batch size field indicates the number of file stream packets in the batch to which the packet in question belongs. (The use of this will be discussed below.)

In the case of file stream packets sent from the client module on the host device 2 to the server module on the storage device 3 (i.e. for slave-to-master, S-M, file stream packets), the packet header simply includes a packet-type field. This is illustrated in FIG. 6B. In this case, the packet type field may indicate either DATA (1) or an acknowledgement, ACK(0x80), or a bit-wise OR of these two types. Any data packet sent from the client module can be flagged as an ACK packet. If the client module needs to send an ACK packet when there are no DATA packets waiting, a NO DATA packet with an ACK flag is created.

For communications from the client module on the host device 2 to the server module on the slave device 3, the client module is configured simply to write appropriate file stream packets to the input file, /fxiin.str, when it has data to transfer. As discussed above, the server module on the storage device 3 when it sees the host device writing to the file /fxiin.str will recognise those data transfers as being data transfers for the server module and so “intercept” such data transfers and pass the file stream packets up the server module protocol stack for processing.

For the case of communications from the server module on the storage device 3 to the client module on the host device 2, again the basic operation of the file stream protocol is to send appropriate file stream packets to the host device 3. However, because of the nature of the communication between the host device 2 and the storage device 3, a number of steps are taken in the present embodiment in order to try to enhance the reliability and efficiency of the server to client communication. In particular, the Applicants have recognised that it may be necessary to take steps to allow for the fact that in the normal course, the expected operation of a host and storage device arrangement via the host device interface 4 is that the host device will act as a master accessing the slave storage device, and it will be assumed that the storage device will not itself contain any “intelligence”.

In the first place therefore the client component of the file stream protocol operates so as to cause the host device to periodically attempt to read the /fxiout.str output file on the storage device 3. This is because any reads of the storage device by the host device must be triggered by the host device itself, as that is the only mechanism that is provided in normal host storage device operation for reading the storage device. The client module therefore causes the host device to poll the storage device periodically, to see if there are any communications from the server module on the storage device waiting.

The output file stream packets to be transferred to the host device when the host device reads the /fxiout.str file are grouped into batches of plural file stream packets, with each batch including up to the number of file stream packets (i.e. blocks) that the host operating system will as a minimum read for each read request. The batch size field in the file stream packet header discussed above indicates the number of file stream packets in the batch to which the packet in question belongs.

This has the advantage of helping to avoid wasting bandwidth when the host device reads the /fxiout.str file, for example where the host device operating system will tend to read more than one block from the storage device in any given read request. Grouping the output file stream packets into batches can help to ensure that each read by the host operating system is “filled” with useful file stream packets.

The file stream protocol is further configured such that the server module on the storage device 3 does not consider a packet batch to have been successfully sent to the client module on the host device 2 until it receives an acknowledgement (ACK) packet from the host device 2. Before this acknowledgement packet is received, the server module keeps resending the same file stream batch every time the host device reads the output file, /fxiout.str. This helps to avoid problems with file stream packets getting lost due to host device operating system reads which the client module has no control of.

To facilitate such acknowledgement operation, the file stream protocol packets include, as discussed above, a packet sequence number in their headers. This packet sequence number is unique and increasing and is used by the client module on the host device to detect if its file stream packet read was correct or not.

If a file stream packet arrives from the storage device with a sequence number that the client module has already processed, the client module considers that an error has occurred (e.g. that the read has in fact come from the host device's cache), and so discards the packet and continues to send its read requests without sending an acknowledgement.

Once the client module receives a complete packet batch with all the file stream packets having the correct sequence numbers, it can be concluded that the batch has been received and read correctly, and so the client module then sends an acknowledgement (ACK) file stream packet to the storage device (by writing the ACK file stream packet to the file /fxiin.str).

The server module on the storage device 3, when it receives this acknowledgement file stream packet from the client module on the host device 2, can then note that the current batch has been successfully received by the client module and so return the next packet batch when the host device 2 next reads the output file /fxiout.str.

The server module further operates in the present embodiment to ensure that the /fxiout.str file contains more output blocks than the host device can keep in its cache. The client module on the host device 2 is correspondingly configured to read blocks from the /fxiout.str file in a random order. Together, this has the effect that any given read of the /fxiout.str file by the host device 2 will tend to result in a cache “miss”, thereby forcing the host device to read from the storage device itself.

This helps to avoid any caching operation on the host device 2 preventing the client module on the host device 2 from receiving new communications from the server module on the storage device 3. In particular, the Applicants have recognised that in normal operation of reading from the storage device 3, the host device 2 may cache a batch of blocks it has read from the storage device 3 and then reread the cached data blocks for subsequent reads of the same file. This could mean that new output packets from the storage device 3 might not be read by the host device, because the host device will tend to make any subsequent reads from its own cache instead of from the storage device. Arranging the output file reading operation to tend to cause the host to encounter cache misses, helps to avoid this problem.

Other arrangements to avoid the host tending to read only from its cache could also or instead be used if desired. For example, if the cache operation on the host device can be disabled, then the client module could be configured to disable the cache operation to ensure that the host device always reads from the storage device and not simply from its cache.

(Any caching operation on the host device should not cause any problem in respect of communications from the client module on the host device 2 to the server module on the storage device 3, because the host device 2 should support FSYNC( ) or equivalent functionality which ensures that any cache changes will always be written back to the storage device 3 in any event.)

FIG. 7 shows schematically the sequence of actions for the client module on the host device when making a read of the output file /fxiout.str on the storage device 3 in accordance with the above arrangement (and in the ideal case where the single read is successful).

As shown in FIG. 7, the sequence starts with the client module (the “slave”) 40 on the host device 2 making a read of a random output block X from the file /fxiout.str (step 41). This read instruction is passed to the host operating system cache 42, which then proceeds, in accordance with its normal procedure, to in fact cache 64 consecutive blocks from the file /fxiout.str from the master storage device 43. Thus, as shown in FIG. 7, the host operating system cache 42 first reads block X and the server module on the master storage device returns output block (file stream packet) number 1. The cache then reads address block X+1 and the server module returns file stream packet number 2, and so on, until 64 consecutive blocks have been requested and returned to the host operating system cache (step 44).

It should be noted here that in this example the batch size is set to 64, so the master server module 43 on the storage device 3 will deliver 64 file stream packets (blocks) to the cache 42. If the cache 42 were to request more blocks than there are file stream packets in a batch, then the master server module 43 would resend all packets until an acknowledgement is received.

Once the host operating system cache 42 has cached all 64 consecutive blocks, it can then return the first packet number 1 to the slave client module 40 (step 45). The slave client module 40 will then attempt to read the next block, X+1. In response to this read, the host operating system cache 42 will return the next packet, packet number 2 (steps 46, 47) and so on.

This will continue until the slave client module 40 has read and received all 64 packets in the batch from the cache 42. Assuming that all the packets in the batch have been correctly and successfully received by the slave module 40, it will then write an acknowledgement block (step 48) to the file /fxiin.str, which will be written back to the storage device 3 via the host operating system cache (step 49).

As will be appreciated from the above, to operate in the above manner, the host device simply needs to support mass storage functions to access the mass storage functions inside the storage device, and also to be capable of running the client module that interacts with the server module on the storage device.

In the above embodiment the client module on the host device 3 acknowledges successful receipt of communication from the server module on the storage device 3 by sending an explicit acknowledgement package to the server module. In another preferred embodiment, the acknowledgement mechanism uses an “implicit” acknowledgement from the client module, without requiring the client module to send an explicit acknowledgement package (thereby saving bus bandwidth).

This is preferably achieved by dividing the output block address space shown in FIG. 5 into two defined output block address ranges, each associated with a respective different output file (such as /fxiout1.str and /fxiout2.str, respectively). The client is then configured to switch to reading a different output file (output address range) once it has checked and confirmed it has successfully read the current output file. The server module can then take the client module's transition to reading from another output file as being an acknowledgement that it has successfully read the previous output file.

FIG. 9 illustrates this. As shown in FIG. 9, the client module first reads block 0 from output file 0 on the storage device. Once it has successfully read the full block 0 from the output file 0, the client module then reads block 10 in output file 1. This implicitly also signals the successful read of block 0 of file 0 to the server module. Then, when the client module has successfully read block 10 from file 1, it next reads block 1 from file 0. This again signals to the server module that block 10 of file 1 has been successfully read, and so on.

In this way, the client module performs an “implicit” acknowledgement when it switches which output block addresses it reads (which it does by switching which output file it reads).

FIG. 8 shows schematically this operation of this embodiment of the present invention when a host device is being used as an input device to control operation of an application in the computing environment 8 of the storage device 3 via the host device interface 4. It is assumed here that the computing environment includes both an application processing part and a separate interface processing part.

FIG. 8 shows schematically the general operation of the system of the present embodiment when an application is being executed on the storage device. As shown in FIG. 8, user inputs 70 such as key presses, audio inputs, Internet information, etc., will be sent from the host device 2 over the host device interface 4 and interpreted by the interface processing part 72 of the computing environment on the storage device 3 which will provide them in an appropriate form to the application processing part 73 on the storage device 3. The application processing part 73 of the storage device will then process the inputs and produce an appropriate output which will then be passed to the interface processing part via the host device interface 4 for appropriate processing and encoding 74 into a form for returning as an image, audio or other generic data stream 75 to the host device 2 for output (e.g. display, sound, etc.) to the user. This process is then repeated as appropriate as the user uses the application being executed on the storage device.

To facilitate this operation, a host device that is operable in the manner of the present embodiment may, e.g., present the user with a display that, for example, includes an icon that the user can use to activate the operation of the client module on the host device 2.

Then, when the user activates this icon on the host device 2, the client module on the host device 2 will start, and, e.g., send an appropriate start command to the server module on the storage device 3 via the host device interface 4. The client module will also cause the host device to read the output, /fxiout.str, file on the storage device 3 periodically. (For the user, the experience may be similar to starting an application in the native user interface of the host device.)

When the server module on the storage device sees the command from the host device, it activates a user interface application in the computing environment 3 and returns an appropriate image stream for display to the host device via the host device interface 4. This image stream may be sent, for example, as raw frame-buffer data, compressed frame-buffer data or a video stream.

The server module may then, e.g., continue to send the image stream to the host device, and the client module on the host device 2 operate to display the corresponding image on the screen on the host device 2. (The image stream can be displayed in any appropriate manner on the host device 2, for example using bit blit to screen if a raw image is streamed, or by decoding the image stream and then bit blit to screen if a compressed image is streamed, or by using appropriate video decoding if the server module sends a video stream.)

The initial image provided by the server module on the storage device 3 may, e.g., simply show an icon representing the application that can be executed on the storage device 3, and this user interface image stream be continuously sent and displayed on the host device 2 until the user activates the icon to start the application. In response to this user input, the client module on the host device may then return a start application command to the storage device 3. The server module on the storage device 3 will recognise that command and, for example, and in the present embodiment, cause the application to be loaded from the flash memory element 5 on the storage device 3 to appropriate DDR RAM 11 on the storage device 3 so that the application can then be executed by the computing environment 8 on the storage device 3.

Once the application is running in the computing environment 8 on the storage device 3, image, audio and other data will be generated by the application running on the storage device 3 and streamed to the host device 2 over the host device interface 4, with the host device 2 similarly sending relevant user inputs, such as key presses or touches, sound and Internet to the storage device 3 (to the server module on the storage device 3), using the above communications protocol. This will continue until the user quits the application. The application may, for example, be the operating system on the storage device 3, a game, a map application, an Internet browser application, a music player, a word processor, a presentation application, a spreadsheet, etc.

Although FIG. 8 shows the operation where the computing environment 8 on the storage device 3 includes a separate interface processing part, this operation could equally be carried out (and in the same manner) when the storage device 3 simply has an application processor like in the arrangement shown in FIG. 1, that performs both the interface processing and application processing functions. In this case, the application processing part will perform both the interface processing and application processing described above in relation to FIG. 8.

As discussed above, as well as being able to couple the storage device 3 to a host device via its host device interface 4, an important feature of the present embodiment is that the storage device 3 can be used to provide a graphical output from an application, etc., running in its computing environment 8, on a display via its display interface 13. This can then be used, for example, to provide computing resources and a display to a screen in a portable form, without the need for the screen itself to have significant computing resources.

FIG. 10 illustrates this, and shows the storage device 3 coupled to a display 15 in the form of an HDMI enabled TV via its HDMI display connector and interface 13. The HDMI enabled TV 15 can be any suitable TV that has an HDMI interface and port capable of receiving and connecting to the display interface and connector 13 of the storage device 3.

The storage device 3 is also connected to an appropriate power source 16 via its host device USB connector 4 to provide power to the storage device 3. The power source 16 can be any suitable power source for powering the storage device 3, such as any 5V power source. It does not have to be a “host device” with any computing resources, but simply needs to be a power source, such as an external battery, a wall socket or a port on the display device itself.

As shown in FIG. 10, in this configuration, the storage device 3 (the application that is generating the graphical output that is being displayed on the display 15) is controlled via a wireless remote 17 that is wirelessly connected to the computing environment 8 of the storage device 3 via the wireless connection 12 of the computing environment 8. The wireless remote 17 can be any device that can act as a wireless remote input device, such as a suitable wireless mouse, keyboard or other input device, such as a smartphone.

In this arrangement, a user will plug the storage device 3 into the display screen 15 via the display interface 13, and power the storage device 3 by connecting it to a power source 16 via its host device USB connector 4. The graphical user interface generated by the computing environment 8 on the storage device 3 is then displayed on the display 15, and the user can use the wireless remote 17 to control and interact with the application, operating system, etc., that is running in the computing environment 8 on the storage device 3. In this way, the storage device 3 can provide a portable computing device that can be used, for example, in combination with an appropriately enabled display, such as a television or other screen.

In the embodiments of the present invention, the various components of the storage device 3 are preferably contained within an appropriate housing, from which the male host device interface 4 and display interface 13 connectors extend (protrude). There is no need for any input or output functions to be provided on the housing, as the input and output functions can otherwise be provided, as discussed above.

While the storage device of the present embodiments (its housing) can have any physical shape and form factor, it is particularly preferred that the storage device of the present invention will be relatively small and portable. Thus, it preferably has an appropriately small and portable form factor, such as a shape and configuration and form factor similar to existing portable mass storage devices, such as USB sticks and thumb drives. It could also, for example, correspond to a smart-phone or tablet form factor. In a particularly preferred embodiment, the body of the storage device of the present invention (the external housing of the storage device of the present invention) (excluding any male connectors that may extend beyond the main body) is preferably not more than 5 cm long, 2 cm wide, and 1 cm thick. FIG. 12 shows an embodiment of the storage device of the present invention having this physical shape and configuration (form factor).

It can be seen from the above that the present invention, in its preferred embodiments at least, provides a mass storage device for use with a host electronic device that also includes general computing resources, including a CPU and/or GPU, able to execute a modern operating system with a graphical user interface like Ubuntu. The device further comprises a display interface, such as an HDMI male connector, and, preferably, wireless connectivity. This allows the storage device to also act, in effect, as a “minimal” computer.

The storage device can thus act as a standard mass storage device, or, in its preferred embodiments at least, can act as an interactive computing device with a host device via the host device interface. It can also operate in a standalone fashion when attached to a screen via its display interface, under the control, for example, of a wireless remote, such as a wireless keyboard or mouse or smartphone. Thus the present invention, in its preferred embodiments at least, can act as a dual purpose device, namely a mass storage device, and as a portable “minimal” computing device with networking.

This is achieved, in the preferred embodiments of the present invention at least, by combining a mass storage device together with computing resources and a minimal set of interfaces required for using the computing resources.

The present invention has no requirement for an integrated power source and no requirement for drivers, and can be easy to use and relatively inexpensive. As the device is portable, it can easily be used as a personal device and, in effect, therefore act as a personal portable computing device.

It can also provide a secure computing environment (and a private computing device), as it can operate such that no data other than user interface images (and audio outputs) will exit the storage device (whether to a connected host device or a display).

The storage device can, for example, be connected to any suitably equipped display unit, e.g. screen, thereby facilitating the provision of computing resources to existing screens and displays having appropriate display interfaces. It can similarly be used in and embedded in any correspondingly equipped home appliances that can connect to the host device interface and/or the display interface of the storage device. It can accordingly also be used to upgrade and provide after market upgrades to various devices such as home appliances that have suitable connection ports.

The present invention can accordingly provide a small, portable, relatively inexpensive and easy to use device, that can, for example, provide computing resources for use with devices, such as screens, that may not otherwise include such resources. For example, the storage device of the present invention can be used to show presentations via display units that do not have any type of computational capabilities, but include a suitable display interface for coupling the storage device of the present invention to the display unit.

The storage device of the present invention can be used, for example, to display files from a computer without, e.g., the display itself having to have any necessary computing resources. In particular, the storage device can be coupled to a host device via its host device interface so as to move files, such as presentations to be displayed, from the computer to the storage device. The storage device can then at a later time be attached to an appropriate display via its display interface, to thereby show or display the files, e.g. presentation, on the screen. The storage device of the present invention can accordingly be used as a “minimal”, portable computing device for, e.g., displaying presentations, as the only equipment required will be the storage device itself and an appropriate wireless remote control. The display unit itself will not need any type of computational capabilities other than to be able to receive and connect to the display interface of the storage device. Thus the storage device of the present invention could be used to provide presentations and displays using any “dumb” screen that has the appropriate display interface.

Further examples for uses of the storage device of the present invention include: the storage device dynamically creating and storing content on the mass storage of the storage device so as to make that content available to a host device, e.g. by downloading and/or streaming data (e.g. music files, video files, text files, data from websites) from the Internet, and storing that data as files on the mass storage of the storage device so as to make the data available to an appropriately connected host device; upon a user attempting to copy a media file from the host device to the storage device, the storage device automatically reformatting the file and storing it on the mass storage of the storage device (either as a new file or overwriting the original file); the application running on the storage device generating new data and/or media files and/or converting data and/or media files; using the storage device as a mobile movie editing studio; using the storage device to run real-time interactive displays and media installations. Other uses would of course be possible.

1. A portable storage device for providing supplemental mass storage to a host electronic device to which the storage device is coupled, the storage device comprising:
non-volatile memory for providing a mass storage function for a host electronic device to which the storage device is coupled;
a host device interface via which the storage device may be coupled to a host electronic device and provide a mass storage function to the host electronic device;
a computing environment operable to execute one or more applications on the storage device; and
a display interface for coupling the storage device to an electronic display, and via which a graphical output generated by an application that is being executed on the storage device may be displayed on a display when the storage device is coupled to a suitable display device via the display interface.

2. The storage device of claim 1, wherein the non-volatile memory is replaceable by a user.

3. The storage device of claim 1, wherein the host device interface comprises a male USB connector.

4. The storage device of claim 1, wherein the storage device is configured to be powered via its host device interface but also includes an internal battery for powering and retaining an internal clock and state settings and for allowing for safe shutdown and to act as a supplemental power source for when the current drawn by the computing environment in use exceeds the maximum current rating of the host device interface.

5. The storage device of claim 1, wherein the storage device is configured such that communication between the storage device and a host device via the host device interface of the storage device can take place by means of the host device acting as a master device reading files from and writing files to the storage device using a conventional storage device mass storage function interface protocol.

6. The storage device of any claim 1, wherein the storage device is configured such that when coupled to a host device via its host device interface, it presents to the host device as a slave mass storage device.

7. The storage device of claim 1, wherein the computing environment of the storage device controls access to and from the mass storage of the storage device via the storage device's host device interface.

8. The storage device of claim 1, wherein the storage device has wireless connectivity to allow its computing environment to access the Internet, and/or to allow a wireless control device to control the operation of the computing environment on the storage device.

9. The storage device of claim 1, wherein the display interface of the storage device is in the form of a male connector for the display interface in question.

10. The storage device of claim 1, wherein the computing environment of the storage device includes a server module operable to interact with a corresponding client module on a host electronic device via the host device interface of the storage device, so as to allow the storage device to use input and output functions of a host electronic device to which the storage device is coupled via the host device interface.

11. The storage device of claim 1, wherein the only physical interfaces to external devices provided on the storage device comprise a single host device interface connector, a single display interface connector, and a single memory card slot for receiving a removable memory card.

12. The storage device of claim 1, wherein the components of the storage device are contained within a housing which, excluding any male connectors that may extend beyond the housing, is not more than 5 cm long, 2 cm wide, and 1 cm thick.

13. A method of operating a system comprising an electronic display and a portable storage device having a host device interface via which the storage device may be coupled to a host electronic device and provide a mass storage function to the host electronic device, the method comprising:
coupling the storage device to the display via a display interface provided on the storage device;
executing an application in a computing environment on the storage device; and
displaying a graphical output generated by the application on the display via the display interface of the storage device.

14. The method of claim 13, comprising coupling the storage device to a power source via its host device interface to power the storage device via its host device interface when displaying a graphical output generated by the application on the display via the display interface of the storage device.

15. The method of claim 13, further comprising wirelessly connecting the storage device to the Internet to allow its computing environment to access the Internet.

16. The method of claim 13, further comprising wirelessly connecting the storage device to a wireless control device, and using the wireless control device to control the operation of the application being executed in the computing environment on the storage device.

17. The method of claim 13, further comprising:
coupling the storage device to a host device via the host device interface of the storage device; and
using the host device to access and control the application being executed in the computing environment on the storage device via the host device interface of the storage device.

18. The method of claim 13, further comprising:
coupling the storage device to a host device via the host device interface of the storage device; and
using a server module on the storage device to interact with a client module on the host electronic device to allow the storage device to use input and output functions of the host electronic device via the host device interface of the storage device.

19. The method of claim 17, wherein communication between the storage device and a host device via the host device interface of the storage device takes place by means of the host device acting as a master device reading files from and writing files to the storage device using a conventional storage device mass storage function interface protocol.

20. The method of claim 13, wherein the application that is being executed in the computing environment of the storage device is an operating system, a game, or a presentation application.

21. (canceled)

22. (canceled)

23. The method of claim 18, wherein communication between the storage device and a host device via the host device interface of the storage device takes place by means of the host device acting as a master device reading files from and writing files to the storage device using a conventional storage device mass storage function interface protocol.

24. A computer readable storage medium storing computer software code which when executing on a processor performs a method of operating a system comprising an electronic display and a portable storage device having a host device interface via which the storage device may be coupled to a host electronic device and provide a mass storage function to the host electronic device, the method comprising:
coupling the storage device to the display via a display interface provided on the storage device;
executing an application in a computing environment on the storage device; and
displaying a graphical output generated by the application on the display via the display interface of the storage device.
